(19) United States
(12) Patent Application Publication
(10) Pub. No.: US 2026/0231060 A1
(43) Pub. Date: Aug. 6, 2026

(54) METHODS, ARCHITECTURES, APPARATUSES AND SYSTEMS TO ENABLE WAKE UP SIGNAL TRANSMISSION FOR ENERGY EFFICIENT SYNCHRONIZATION SIGNAL BLOCK (SSB) SIGNALS AND PATTERNS

(71) Applicant: InterDigital Patent Holdings, Inc., Wilmington, DE (US)

(72) Inventors: Jaya Rao, Montreal (CA); Tao Deng, New York, NY (US); Faris Alfarhan, Montreal (CA); Paul Marinier, Brossard (CA); Umer Salim, Vallauris (FR); Janet Stern-Berkowitz, Little Neck, NY (US)

(21) Appl. No.: 19/044,130

(22) Filed: Feb. 3, 2025

(51) Int. Cl. H04W 56/00; H04B 17/318; H04W 52/02; H04W 74/0833

(52) U.S. Cl. CPC H04W 56/0015; H04B 17/328; H04W 52/0229; H04W 74/0833

(57) ABSTRACT

Procedures, methods, architectures, apparatuses, systems, devices, and computer program products related to wake up signal transmission for energy efficient synchrnoziation signal block (SSB) signals and/or patterns. A method may include a wireless transmit/receie unit (WTRU) receiving a first type of SSB signal(s) (e.g., SSB-a signals) that may include or indicate synchronization signal(s) and/or light physical broadcast channel (PBCH), transmitting a wake-up signal (WUS) indication using resources provided in the light PBCH of the first type of SSB signal(s) to request a second type of on-demand SSB signal(s) (e.g., on demand SSB-b signals), determining the candidate time and/or frequency locations for receiving the second type of on-demand SSB signal(s) based on the information in the light PBCH and/or information included in a WUS response indication received from the network.

### FIELD

Example embodiments described in the present disclosure are generally directed to the fields of communications, software and encoding, including, for example, to methods, architectures, apparatuses, and/or systems related to wake up signal transmission for energy efficient synchrnoziation signal block (SSB) signals and/or patterns.

### BACKGROUND

The current standards enable a network to minimize its energy consumption due to transmissions and receptions. Such network energy savings (NES) capabilities may include performing adaptations in multiple domains including in spatial domain, time domain, frequency domain, or power domain.

### SUMMARY

An embodiment may be directed to a wireless transmit/receive unit (WTRU), which may include circuitry, including any of a processor and transceiver. The WTRU and/or circuitry may be configured to receive synchronization signal block (SSB) configuration information indicating (1) one or more parameters associated with a first synchronization signal block (SSB) type, (2) one or more parameters associated with a second synchronization signal block (SSB) type, (3) wake-up signal (WUS) configuration(s), and/or (4) an association between the wake-up signal (WUS) configurations and the first synchronization signal block (SSB) type. The WTRU and/or circuitry may be configured to receive a first synchronization signal block (SSB) associated with the first synchronization signal block (SSB) type (e.g., to receive a first type of SSB signal). The first synchronization signal block (SSB) comprises one or more synchronization signals and/or a first type of physical broadcast channel (PBCH). The first type of PBCH (e.g., light PBCH) includes or indicates first information indicating or comprising (1) a parameter indicating an association between a periodicity of the first synchronization signal block (SSB) type and one or more of the wake-up signal (WUS) configurations and/or (2) wake-up signal monitoring configuration information. The WTRU and/or circuitry may be configured to transmit a wake-up signal (WUS) using one of the wake-up signal (WUS) configurations determined at least in part based on the first information included in the first type of physical broadcast channel (PBCH). The WTRU and/or circuitry may be configured to receive a wake-up signal (WUS) response indication based on the wake-up signal monitoring configuration information.

An embodiment may be directed to a method implemented by a wireless transmit/receive unit (WTRU). The method may include receiving synchronization signal block (SSB) configuration information indicating (1) one or more parameters associated with a first synchronization signal block (SSB) type, (2) one or more parameters associated with a second synchronization signal block (SSB) type, (3) wake-up signal (WUS) configuration(s), and/or (4) an association between the wake-up signal (WUS) configurations and the first synchronization signal block (SSB) type. The method may include receiving a first synchronization signal block (SSB) associated with the first synchronization signal block (SSB) type. The first synchronization signal block (SSB) may include one or more synchronization signals and/or a first type of physical broadcast channel (PBCH). The first type of PBCH may include first information indicating (1) a parameter indicating an association between a periodicity of the first synchronization signal block (SSB) type and one or more of the wake-up signal (WUS) configurations and/or (2) wake-up signal monitoring configuration information. The method may include transmitting a wake-up signal (WUS) using one of the wake-up signal (WUS) configurations determined at least based on the first information included in the first type of physical broadcast channel (PBCH), and receiving a wake-up signal (WUS) response indication based on the wake-up signal monitoring configuration information.

In an embodiment, the method may include, or the WTRU configured for, determining, based on the first information included in the first type of physical broadcast channel (PBCH) and the wake-up signal (WUS) response indication, any of time and frequency locations of at least one on-demand synchronization signal block (SSB), wherein the at least one on-demand synchronization signal block (SSB) is associated with the second synchronization signal block (SSB) type.

In an embodiment, the method may include, or the WTRU configured for, receiving the at least one on-demand synchronization signal block (SSB) in any of the time and frequency locations, and/or transmitting an indication, to a network node, based on information, such as resource information, in a selected one of the at least one on-demand synchronization signal block (SSB).

In an embodiment, the association between the wake-up signal (WUS) configurations and the first synchronization signal block (SSB) type comprises an association between the wake-up signal (WUS) configurations and properties associated with signals of the first synchronization signal block (SSB) type.

In an embodiment, the wake-up signal is transmitted on condition that a triggering criteria is met, the triggering criteria comprising any of: a reference signal received power (RSRP) associated with the first synchronization signal block (SSB) being greater than a threshold, and/or a time gap to a nearest synchronization signal block (SSB) of a second synchronization signal block (SSB) type signal being greater than a threshold.

In an embodiment, the second synchronization signal block (SSB) type comprises any of always-on synchronization signal blocks (SSBs) and on-demand synchronization signal block (SSBs), where the always-on synchronization signal blocks (SSBs) are received with a predetermined periodicity, and wherein the on-demand synchronization signal blocks (SSBs) are received in response to a wake-up signal (WUS).

In an embodiment, the wake-up signal (WUS) response indication indicates any of: (1) an association between a scaling factor for a periodicity associated with the at least one on-demand synchronization signal block (SSB) and a periodicity associated with the first synchronization signal block (SSB) associated with the first synchronization signal block (SSB) type, (2) an association between a duration of the at least one on-demand synchronization signal block (SSB) and any of a symbol duration and periodicity of the first synchronization signal block (SSB) associated with the first synchronization signal block (SSB) type, and/or (3) any of a start time and frequency offset of the on-demand SSB.

In an embodiment, the first type of physical broadcast channel (PBCH) may be a light physical broadcast channel (PBCH) having a smaller payload than a second type of physical broadcast channel (PBCH) (e.g., having a complete or normal payload).

In an embodiment, the method may include, or the WTRU may be configured to, perform measurements on the at least one on-demand synchronization signal block (SSB) to determine the selected one of the at least one on-demand synchronization signal block (SSB) to use to transmit the indication to the network node.

In an embodiment, the method may include, or the WTRU may be configured to, monitor resources indicated in the wake-up signal monitoring configuration information for an indication that transmission of the on-demand synchronization signal blocks (SSBs) is or will be terminated.

In an embodiment, the indication transmitted to the network node comprises a physical random access channel (PRACH) transmission that is transmitted using resources associated with the selected one of the at least one on-demand synchronization signal block (SSB).

In an embodiment, the method may include, or the WTRU may be configured to, based on the selected one of the at least one on-demand synchronization signal block (SSB), receive system information (SI) associated with the network node.

In an embodiment, the parameters associated with the first synchronization signal block (SSB) type and the parameters associated with the second synchronization signal block (SSB) type comprise any of: identifiers associated with the first synchronization signal block (SSB) type and the second synchronization signal block (SSB) type, synchronization signal block (SSB) resources, synchronization signal block (SSB) ports, resource type, active resources in a burst, periodicity, usage type, slot level periodicity, slot level offset, synchronization signal block (SSB) beam bandwidth, frequency hopping information, guard period, synchronization signal block (SSB) comb pattern information, comb offset hopping pattern with repetition, synchronization signals, beam transmit power, power control parameters, and/or reference beam information.

In an embodiment, the wake-up signal (WUS) configuration(s) may include at least an indication of resources associated with the wake-up signal (WUS).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example illustrating the information elements that may be carried by physical broadcast channel (PBCH) and master information block (MIB), according to some embodiments;

FIG. 3 illustrates an example of an SSB burst with a periodicity of 20 ms, according to some embodiments; and

FIG. 4 illustrates an example procedure for WUS transmission, reception of an WUS response indication and on demand SSB-b transmission, according to some embodiments;

FIG. 5 illustrates an example of WUS transmission, according to some embodiments; and

FIG. 6 illustrates an example flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

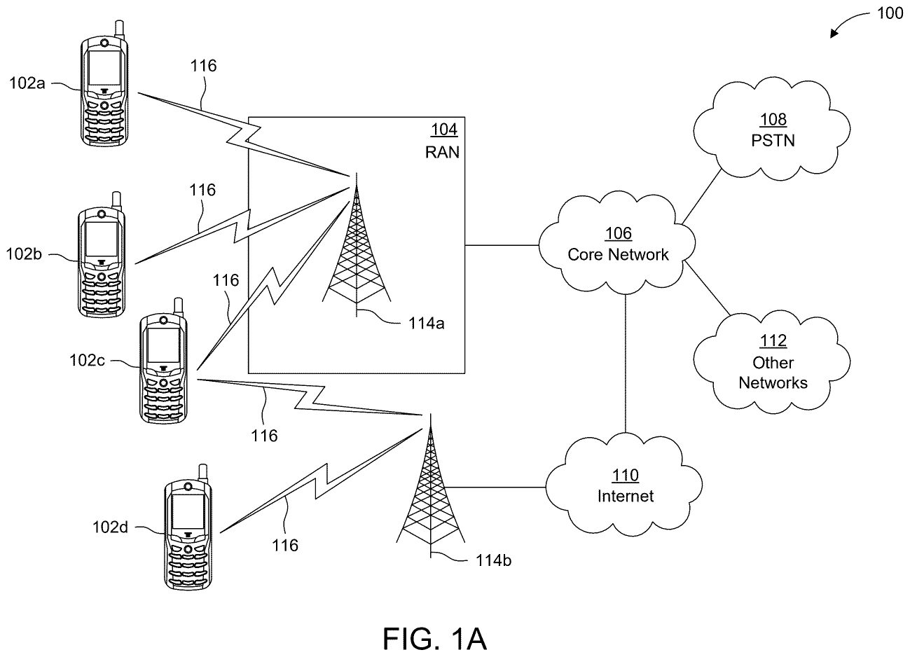

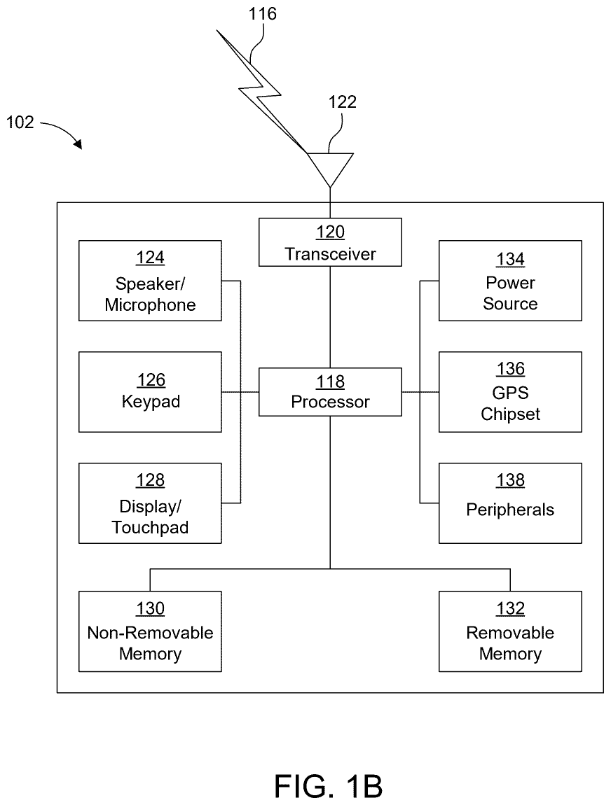

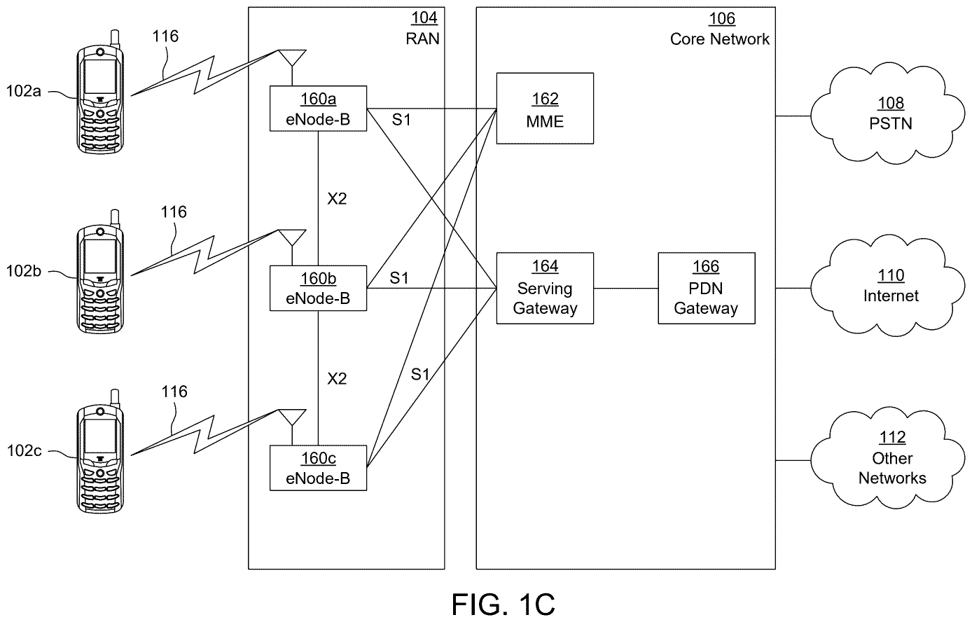

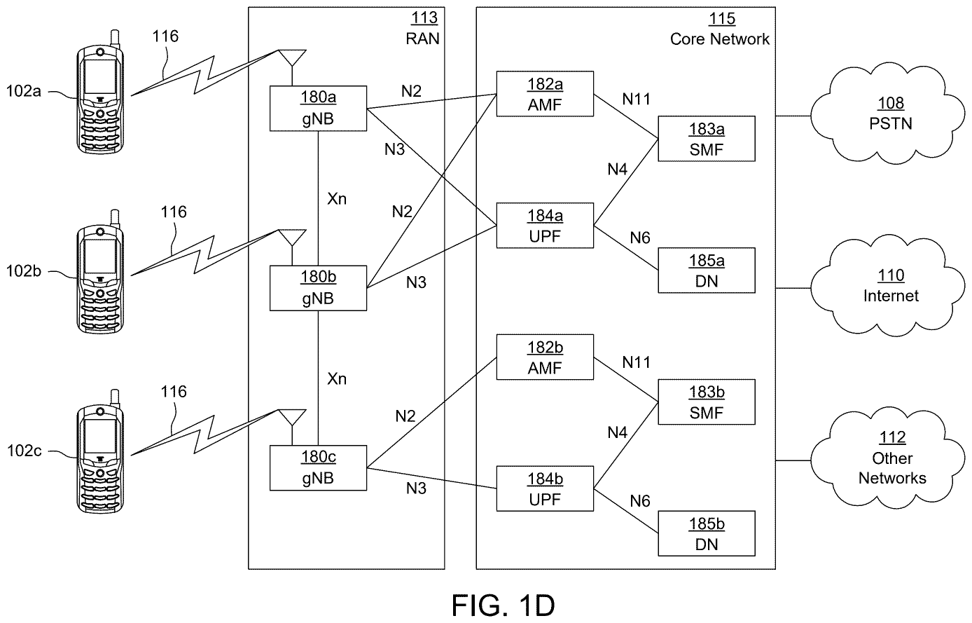

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

The current standards enable the network to minimize its energy consumption due to transmissions and receptions. Such network energy savings (NES) capabilities may include performing adaptations in multiple domains including in the spatial domain (e.g. power off subsets of antenna ports, elements or panels), time domain (e.g. apply cell DTX/DRX or apply long periodicity for SSB transmissions), frequency domain (e.g. disable certain carriers or BWPs), and/or power domain (e.g. apply lower power offset values).

While the NES enhancements supported in Release 18 (R18) and Release 19 (R19) were specified with the assumption that the network (NW) is lightly or moderately loaded in terms of achievable throughput by the WTRUs in cells, future releases or generations are expected to support more advanced capabilities and features for NES even in high load scenarios. For improving NES gains, the NW nodes that may be operating in NES modes (e.g. reduced transmission of common signals/channels such as SSBs) are expected to be quickly transitioned to partial or full operating capability. Such capability can enable the network to dynamically operate in different modes irrespective of load conditions or the WTRU modes. In essence, there needs to be faster and more efficient adaptation at NW, especially for the transmission of common signals and/or channels (e.g. sync signals, RS, MIB). Thus, it may be desirable to support on-demand transmissions of SSBs for WTRUs in IDLE mode, where most energy savings at NW may be possible.

SSBs transmitted by a cell (e.g. operating in NES mode) may include one or more the following (e.g. in 6G): a first type of SSB (e.g., which may be referred to as SSB-a) and a second type of SSB (e.g., which may be referred to as SSB-b).

The first type of SSB, e.g., SSB-a, may include signals, such as light sync signals (e.g., one or two sync signals that may use limited sequence length and/or resources) and a first PBCH type, which may be referred to herein as a light PBCH (e.g. contains small payload). The first type of SSB (e.g., SSB-a) may have a periodicity that is shorter relative to the periodicity of the second type of SSB (e.g. periodicity of SSB-a may be 20 ms).

The second type of SSB, e.g., SSB-b, may include signals, such as PSS/SSS, a second PBCH type that may contain a larger PBCH payload and may include one or more of MIB, SFN information, other timing information. The second type of SSB (e.g., SSB-b) may have a periodicity that is longer relative to the periodicity of the first type of SSB, SSB-a, (e.g., periodicity of SSB-b may be >=160 ms).

A network (NW) may have a configuration such that a standalone NES cell may transmit SSB-a and may be woken up (e.g. to transmit SSB-b) with (e.g., using) an uplink (UL) wake-up signal (WUS). The network may include a multi-cell deployment that includes one or more NES cells that are overlaid on a coverage cell (e.g., Cell A). Cell A may transmit both SSB-a (e.g., short periodicity) and always-on SSB-b (e.g., long periodicity). One or more additional SSB-b may be transmitted by Cell A on an on-demand basis (e.g., OD-SSB-b). A NES cell may transmit SSB-a (short periodicity) and SSB-b only on an on-demand basis.

A WTRU (e.g., IDLE mode) may be predefined or preconfigured with (e.g., may receive configuration information indicating) parameters of (possible) SSB-a and SSB-b configurations and information on how SSB-a and SSB-b are associated.

A WTRU may be expected to (e.g., configured to) transmit UL-WUS (e.g., when meeting the triggering criteria) for requesting OD-SSB-b transmission from a cell (e.g., a network node), and/or to select the best cell (e.g., in multi-cell deployment) to transmit an UL-WUS signal.

Some problems addressed by example embodiments described herein may relate to the NES cells that transmit 6G SSBs (e.g., SSB-a and SSB-b), and/or to enabling UL-WUS and on-demand SSB transmission in single and multi-cell deployment scenarios.

In NR, SSBs are used to support both IDLE mode (e.g., sync, initial access, paging, RA) and CONNECTED mode (e.g., measurements, QCL source, RLM, BM) functions. This requires dense SSB transmission with short periodicity (20 ms) and across multiple frequency locations. R19 NES is introducing on-demand SSBs (OD-SSBs) for WTRUs in CONNECTED mode. However, the R19 scenarios where OD-SSBs may be applicable are limited to only carrier aggregation (CA) operation during the activation of SCell.

A synchronization signal block (SSB) may include one or more synchronization (sync) signals and/or one or more physical broadcast channels (PBCH). Each sync signal and each PBCH may occupy one or more symbols. A typical periodicity for an SSB (e.g., in 5G) may be, for example, 20 ms. Using longer periodicity (e.g., >=160 ms) for SSBs (e.g., in 6G) can enable high network energy savings (NES) (e.g., 77%). However, the expected increase in latency and WTRU processing during cell search and initial access (e.g., increase 20 ms to 160 ms) may pose a problem (e.g., may result in an unacceptable level of increased latency and processing). Thus, a problem arises as to how to enable on-demand SSB transmission in idle mode without impacting NES gains with longer periodicity SSBs, and/or how to minimize the resources and/or overhead used for triggering the on-demand SSB transmissions.

As will be discussed in more detail in the following, according to an embodiment, upon receiving SSB-a signals (e.g., sync+light PBCH), a WTRU may transmit an UL-WUS indication using resources provided in the light PBCH of SSB-a to request for on demand SSB-b signals (e.g., when meeting the triggering criteria). The WTRU may determine the candidate time and/or frequency locations for receiving on-demand SSB-b signals based on the information in the light PBCH and/or a WUS response indication.

According to certain embodiments, a WTRU is predefined with (e.g., may receive configuration information indicating) parameters of SSB-a configuration(s) and SSB-b configuration(s) (e.g., always-on and on-demand SSB-b configurations) and an association between UL-WUS configuration(s) (e.g., WUS resources or resource configurations) and SSB-a (configurations). For example, an association between one or more UL-WUS configurations and SSB-a configuration(s) may include that UL-WUS resources (e.g., PRACH preambles, RACH occasions in TD/FD) may be associated with the properties of SSB-a signals (e.g. periodicity, symbol duration, scrambling sequence on sync signal).

In certain embodiments, the WTRU may receive SSB-a signals, which may contain one or more sync signals and light PBCH. For example, light PBCH may include: parameter(s) used in combination with the periodicity of SSB-a for associating with different UL-WUS configurations (e.g., 2 bits for indicating one of 4 UL-WUS configs per SSB-a periodicity), and/or WUS response monitoring configuration information (e.g. time, frequency, code resource set, CORESET, and/or search space information). As one non-limiting example, WUS response monitoring configuration information might be or may include 2 bits for indicating one of 4 different monitoring configuration multiplexing patterns).

According to some embodiments, the WTRU may transmit an UL-WUS (e.g., when a certain criteria is met) based on SSB-a measurements and/or information in the light PBCH of SSB-a (e.g., the WUS may be transmitted using one of the WUS configurations that may be determined at least based on the information included in the light PBCH). For example, the WTRU may transmit a WUS if a certain criteria (e.g., triggering criteria) is met. As some examples, the (triggering) criteria for transmitting UL-WUS may include any of: the RSRP (e.g., associated with SSB-a) is greater than a threshold, and/or a time gap to the nearest always-on SSB-b signal is greater than a threshold. For example, an UL-WUS may be a cell-specific resource (e.g., sequence, PRACH resource, etc.). For example, the WTRU may transmit UL-WUS using a transmit power level adjusted based on the (pathloss) measurements made on the SSB-a signals.

In certain embodiments, the WTRU may receive a WUS response indication based on or using the monitoring configuration. For example, a WUS response may include any of: scaling factor for periodicity of OD-SSB-b that may be associated with periodicity of SSB-a (e.g. 2 bits), duration of OD-SSB-b that may be associated with symbol duration and/or periodicity of SSB-a (e.g. 2 bits), and/or start time and/or frequency offset of OD-SSB-b (e.g. 2 bits).

According to some embodiments, the WTRU may determine the time and/or frequency (T/F) locations of OD-SSB-b signals based on the information in the light PBCH and/or WUS response indication. For example, for an WUS response indication received in SFN #x, the WTRU may determine the candidate time locations for OD-SSB-b with the indicated start offset (e.g. 1 SFN) and duration (e.g. 4 SFNs) as {SFN #x+1+i, where i=1, 2, 3, 4}.

In certain embodiments, the WTRU may receive OD-SSB-b signals in the determined T/F locations. For example, the WTRU may perform measurements on the OD-SSB-b signals (e.g. for the indicated duration based on a timer) and/or select a best SSB-b signal/beam. Alternatively or additionally, for example, the WTRU may monitor the resources in the WUS response monitoring configuration for receiving any indication on stopping of OD-SSB-b (e.g., monitor for an indication that the network or cell is or will terminate the transmission of OD-SSB-b).

According to some embodiments, optionally, the WTRU may determine an OD-SSB-b to use (e.g. based on measurements). The WTRU may receive the SI associated with the cell based on the determined OD-SSB-b. In some examples, the WTRU may transmit an indication (e.g. PRACH) to the cell based on the OD-SSB-b (e.g. using PRACH resources associated with the OD-SSB-b). For example, the WTRU may send an indication, to the network, based on information in the OD-SSB-b that the WTRU has determined to use.

Example embodiments described herein provide several benefits and/or advantages. For example, a benefit includes incurring lower energy usage due to transmitting different SSB types from cells (e.g. dense SSB-a with small payload and sparse SSB-b with bigger payload). Additionally, example embodiments result in lower overhead for indicating the UL-WUS resource configuration. Further, example embodiments provide for flexible transmission of on-demand SSBs. Other benefits may also be incurred according to example embodiments.

As referred to herein, a Synchronization Signal Block or SS/PBCH block (SSB) may include at least one of the following: synchronization signals such as PSS (Primary Synchronization Signal) and SSS (Secondary Synchronization Signal), Physical Broadcast Channel PBCH (Data), Master information block (MIB) and PBCH (DMRS). The SSBs may be transmitted by the NW node (e.g. base station, TRP, relay node, RIS unit) in different directions as beams. The number of SSB beams in an SSB burst set, which may be transmitted periodically within an interval (e.g. 5 ms) may depend on the carrier frequency. For example, an SSB burst may contain 4 SSBs for FR 1 (<3GHZ), 8 SSBs for FR 1 (3 to 6 GHZ) and 64 SSBs for FR 2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the NW node or WTRU (e.g. via transmission of an UL WUS). Some SSBs may include slim/lean SSBs, which may be comprised of PSS only, PSS and SSS-only, PBCH or a subset of MIB-only, for example.

A channel state information reference signal (CSI-RS) may include at least one of the following: CSI-RS resource set (ID), CSI-RS resource (ID/index), resource mapping, power control offset values (e.g. with respect to PDSCH, SSB), scrambling ID, periodicity, offset and QCL info. CSI-RS may be transmitted in DL by the NW node as CSI-RS beams, via different resource types including periodic, semi-persistent and aperiodic.

Channel state information (CSI) may include at least one of the following: channel quality index (CQI), rank indicator (RI), precoding matrix index (PMI), an L1 channel measurement (e.g. RSRP such as L1-RSRP, or SINR), CSI-RS resource indicator (CRI), SS/PBCH block resource indicator (SSBRI), layer indicator (LI) and/or any other measurement quantity measured by the UE from the configured CSI-RS or SS/PBCH (SSB) block.

A property of scheduling information (e.g., an uplink grant or a downlink assignment) may include at least one of the following: a frequency allocation; an aspect of time allocation, such as time instance and/or a time duration; a priority; a modulation and coding scheme; a transport block size; a number of spatial layers; a number of transport blocks to be carried; a TCI state or SRI; a number of repetitions; whether the grant is a configured grant type 1 (i.e., UE immediately using the configured UL resources after receiving the configuration information), type 2 (i.e., UE waiting until an explicit MAC CE indication before using the configured UL resources) or a dynamic grant.

An indication by DCI, or an indication, may include at least one of the following: an explicit indication by a DCI field or by RNTI used to mask CRC of the PDCCH; an implicit indication by a property such as DCI format, DCI size, Coreset or search space, aggregation level, identity of first control channel resource (e.g., index of first CCE) for a DCI, where the mapping between the property and the value may be signaled by RRC or MAC; and/or an explicit indication by a DL MAC CE.

In example embodiments described herein, the network may include any of a base station (e.g., gNB, TRP, RAN node, access node, NTN node, IAB node, RIS unit/node), core network function (e.g. AMF, SMF, PCF, NEF) and/or application function (e.g. edge server function, remote server function), for example. NES cells may refer to any of the network nodes that may be operating in an NES state/mode, including any of time, frequency, spatial and/or power domain adaptation modes.

In example embodiments described herein, NES adaptations may include any of the adaptations at NW in the spatial domain (e.g. power off subsets of antenna ports, elements or panels), time domain (e.g. (de)activation of cell DTX/DRX, apply long periodicity or sparse transmissions of common signals/channels), frequency domain (e.g. disable certain carriers or BWPs) or power domain (e.g. apply lower power offset values).

It is noted that the terms ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Synchronization signals and procedures in 5G NR include downlink synchronization, which is the process in which a WTRU detects the radio frame boundary (i.e., the exact timing when a radio frame starts) and OFDM symbol boundary (i.e., the exact timing when an OFDM symbol starts). This process is done by detecting and analyzing synchronization signal Block, termed as SSB.

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS as show in the figure below. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). An SpCell is associated (e.g., always associated) to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency multiplexed DMRS. QPSK modulation is used for PBCH.

Cell search is the procedure by which a WTRU acquires time and frequency synchronization with a cell and detects the Cell ID of that cell. NR cell search is based on the primary and secondary synchronization signals, and PBCH DMRS, located on the synchronization raster.

System Information (SI) is divided into the master information block (MIB) and a number of system information blocks (SIBs). The MIB is transmitted (e.g., always transmitted) on the BCH with a periodicity of 80 ms and repetitions made within 80 ms (TS38.212) and it includes parameters that are needed to acquire SIB1 from the cell. The SIB1 is transmitted on the DL-SCH with a periodicity of 160 ms and variable transmission repetition periodicity within 160 ms as specified in 3GPP TS 38.213. The default transmission repetition periodicity of SIB1 is 20 ms but the actual transmission repetition periodicity is up to network implementation. MIB and SIB1 make up the minimum system information (MSI) required to operate on a cell.

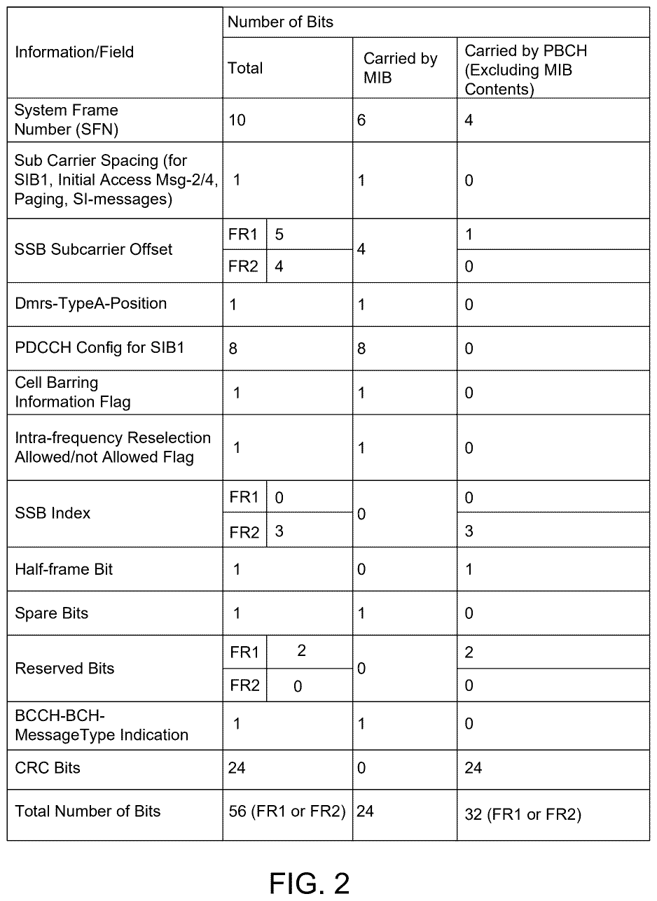

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the WTRU may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected. FIG. 2 is an example table that illustrates the information elements that may be carried by PBCH and MIB (in terms of number of bits).

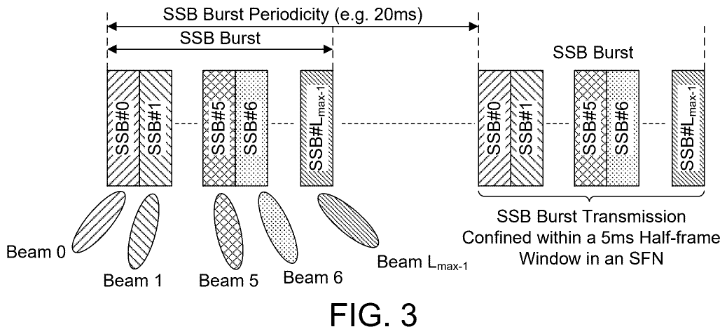

In certain embodiments, each SSB within an SSB burst set (i.e., all of the SSBs within the 5 ms period of the SSB transmission) is assigned with a unique number starting from 0 and increasing by 1. This number resets to 0 in the next SSB burst set (i.e., next 5 ms span after SSB transmission cycle, e.g., after the default cycle of 20 ms). This unique number (i.e., SSB Index) is informed to the WTRU via PBCH DMRS and via PBCH payload. The candidate SSBs in a half frame are indexed in an ascending order in time from 0 to L−1. A WTRU may determine the 2 LSB bits, for L=4, or the 3 LSB bits, for L>4, of a SSB index per half frame from a one-to-one mapping with an index of the DMRS sequence transmitted in the PBCH. For L=64, the WTRU may determine the 3 MSB bits of the SS/PBCH block index per half frame by PBCH payload bits. FIG. 3 illustrates an example of an SSB burst with a periodicity of 20 ms and, in particular, depicts SSB beam sweeping within SSB burst.

Upon detection of a SSB, the WTRU may determine from MIB that a CORESET for Type0-PDCCH common search space (CSS) set is present if the SSB subcarrier offset (k_{SSB}) <24 for FR1 or if k_{SSB}<12 for FR2. The WTRU determines from MIB that a CORESET for Type0-PDCCH CSS set is not present if k_{SSB}22 23 for FR1 or if k_{SSB}>11 for FR2; the CORESET for Type0-PDCCH CSS set may be provided by PDCCH-Config.

PDCCH-Config in the MIB is indicated by 8 bits, where 4 LSB bits indicate the CORESET multiplexing pattern corresponding to search space (SS) 0 and the 4 MSB bits indicate the CORESET 0.

For SSB and CORESET multiplexing pattern 1, SIB1 repetition transmission period is 20 ms. For SSB and CORESET multiplexing pattern 2/3, SIB1 transmission repetition period is the same as the SSB period (e.g., 3GPP TS 38.213). SIB1 includes information regarding the availability and scheduling (e.g., mapping of SIBs to SI message, periodicity, SI-window size) of other SIBs with an indication whether one or more SIBs are only provided on demand and, in that case, the configuration needed by the UE to perform the SI request. SIB1 is cell-specific SIB.

A WTRU may transmit or receive a physical channel or reference signal according to at least one spatial domain filter. The term “beam” may be used to refer to a spatial domain filter. The WTRU may transmit a physical channel or signal (e.g. PUCCH, PUSCH, SRS) using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal. A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

Herein, an SSB may refer to one or more SSB beam (spatial relation) within a collection of SSBs (SSB burst). An SSB may refer to a beam-and vice-versa-or a CSI-RS resource related to the beam. SSB, SSBs, and/or SSB burst may loosely refer to one or more beams transmitted from a TRP or a NW node.

In example embodiments described herein, the terms ‘RS’, ‘RS beams’, ‘SSB’ and ‘SSB beams’ may be used interchangeably. Also, the terms SSB-a, sync signals, type-1 SSBs may be used interchangeably. Also, the terms SSB-b, full SSBs, type-2 SSBs may be used interchangeably. Also, the terms ‘RS config, ‘RS beam config’, ‘NES-RS config’, ‘SSB pattern’ and ‘SSB config’may be used interchangeably.

In one embodiment, the WTRU may be predefined and/or receive configuration information, and/or sub-configurations (e.g. subset of parameters associated with a configuration) associated with reference signals (RS). Such RSs (e.g. applicable in DL) may include any of the following: First SSB (SSB-a), Second SSB (SSB-b), Legacy NR/5G SSB, Measurement RS (e.g. SSB-a, SSB-b, DMRS, CSI-RS, TRS, PTRS), NES-RS, and/or Light-RS.

A first SSB (SSB-a) may include signals, such as light sync signals (e.g. one or two sync signals that may use limited sequence length and/or resources) and a first PBCH type, which may be referred to herein as a light PBCH (e.g. contains small payload). The first SSB may have a periodicity that is shorter relative to the periodicity of SSB-b (e.g. periodicity of SSB-a is 20 ms). The first SSB may have TD properties that may be located on even/odd SFNs, first/second half-frame index, set of OFDM symbols in a slot/subframe. The first SSB may have FD properties, e.g., on/off sync raster (e.g. 5G/6G bands, perched carriers), may or may not overlap in FD with SSB-b (e.g. located on same/different carriers than SSB-b). The first SSB may have SD/beam properties, e.g., wide beams (typical) and narrow beams (e.g. same beam indexes as SSB-b beams, same QCL assumption as SSB-b beams). The first SSB may have an associated type, e.g., always-on periodic (e.g. for coverage), semi-persistent, on-demand (NW-triggered, UE triggered). The first SSB may have an associated usage, e.g., assist IDLE mode (camping, T/F sync, access SSB-b/SI), CONN mode (e.g. for L1 measurements, mobility, RLM/BM).

A second SSB (SSB-b) may include signals, such as one or two sync signals (e.g. PSS/SSS, sync signals that may use longer sequence length and/or resources) and a second PBCH type which may contain a larger PBCH payload, e.g., PBCH-DMRS, MIB, SIB1, SI. The second SSB may have a periodicity that is longer relative to the periodicity of SSB-a (e.g. Periodicity of SSB-b is >=160 ms). The second SSB may have TD properties that may be in any SFN/half-frame/subframe/slot (for flexibility). The second SSB may have FD properties, e.g., On/off sync raster (e.g. 5G/6G bands, perched carriers, anchor carriers). The second SSB may have different SSB-b configs on different carriers may overlap/aligned in TD. In some deployments (e.g. small cell), SSB-b on different carriers may not overlap in TD. The second SSB may have SD/beam properties, e.g., narrow beams (typical) and wide beams. The second SSB may have an associated transmission type, e.g., always-on (for coverage), on-demand (NW-triggered, UE triggered). The second SSB may have an associated usage, such as IDLE mode (sync, camping, RACH) and CONNECTED mode (L1/L3 RRM measurements). The second SSB may have or include new RS/SSBs that may include additional/lower set of resources/signals/parameters than those in legacy SSBs, including a combination of PSS/SSS, MIB, PBCH, pre-SIB1, SIB1, RACH config, UL WUS config, PUCCH resource config, SDT resources, SRS resources, etc.

A legacy NR/5G SSB may include cell defining SSBs (CD-SSB) or non-cell defining SSBs (NCD-SSBs). Frequency locations of the SSBs that are on and off sync raster (e.g. GSCN, ARFCN or other sync raster).

Measurement RS may include, for example, SSB-a, SSB-b, DMRS, CSI-RS, TRS, PTRS.

NES-RS may include on-demand SSBs (OD-SSBs) that may be available in a certain duration/window with certain periodicity/inter-burst gap, from a reference/start time onwards. UE/group-specific RS (e.g. a set of RS beams that may be triggered/transmitted for a UE/UE group).

A light-RS may be a RS that may contain a combination of one or more sync signals, PSS, SSS, discovery reference signal (DRS), PBCH only, SIB1 only.

Such configuration for RS (RS config) may be applicable for supporting one or more NES adaptations in different any of time, frequency, spatial and power domains, for example. Such configurations/parameters may be applicable for any of the solutions described herein. In examples described herein, the terms ‘NES-RS’, ‘Enhanced RS’, ‘measurement RS’ and ‘light RS’ may be used interchangeably when referring to any reference signals that may or may not be identical to the legacy SSBs. Additionally, the term ‘SSB/RS config’ may apply to any of SSB-a and SSB-b configs. In the examples described herein, the terms ‘SSB-a’, ‘SSB-a signals’ and ‘SSB-a transmissions’ may be used interchangeably, to refer to any of the signals or transmissions associated with SSB-a. The same applies for SSB-b. The term ‘always-on’ may refer to any signals/beams associated with SSB-a and SSB-b that may be transmitted or received periodically. The term ‘on-demand’ may refer to any signals/beams associated with SSB-a and SSB-b that may be transmitted or received aperiodically or semi-statically (e.g. N transmissions), possibly over a certain time duration or window.

The configurations/sub-configurations associated with SSB/RS, at least in part, may be received in broadcast transmission (e.g. PBCH, MIB, SI, SIBx) or in dedicated RRC signaling (e.g. in RRCReconfiguration message) during CONNECTED mode or in INACTIVE/IDLE mode (e.g. RRCRelease message, when transitioning from CONNECTED mode to INACTIVE mode, or in PCBH, paging DCI in IDLE mode). Alternatively, any of the configurations, sub-configurations and parameters may be received by the UE, at least in part, in one or more dynamic signaling indications (e.g. in MAC CE or DCI) or in NES/cell activity indications, for example. Such NES/cell activity indications may be received in RRC signaling, MAC CE, DCI (e.g. UE-specific or group common DCI) or PDSCH, for example. In an example, the UE may receive a first subset of parameters associated one or more RS configs in PBCH/MIB/SIBx/RRC signaling and a second subset of parameters or update to the parameters in the first subset may be received in dynamic signaling (e.g. MAC CE, DCI).

The WTRU may receive, in configuration information, one or more of the following parameters associated with the SSB/RS config or sub-configs: identifiers or indexes associated with a SSB/RS, SSB/RS resources, SSB ports, resource type, active resources in a burst, periodicity, usage type, slot level periodicity, slot level offset, SSB beam bandwidth, frequency hopping information, guard period, SSB comb pattern information, comb offset hopping pattern with repetition, synchronization signals, beam transmit power, power control parameters, and reference beam information.

For example, a WTRU may receive indexes/IDs of one or more SSB/RS configs (e.g. SSB-a config, SSB-b configs), SSB/RS resource sets or resources.

For example, a WTRU may receive SSB/RS resources that may include any of the following: time domain resources, frequency domain resources, spatial domain resources, and the like. Time domain resources may include a number of symbols per slot (e.g. 1, 2, 4 symbols per slot), start offset symbol, repetition factor, burst periodicity, duration/window of RS transmission, time gap between beams/RS/bursts, and/or comb/interleaving pattern. When the RS configs correspond to an SSB transmission config/pattern, the config/pattern may indicate the candidate locations of the SSBs in SSB bursts in terms of any of the following parameters: SFN index (e.g. even or odd indexes), half-frame index (e.g. first or second half of a frame), subframe, slot, symbol.

For example, frequency domain resources may include a number of PRBs, center frequency, start offset PRB (e.g. from a reference location), repetition factor, comb pattern, raster location (e.g. on GSCN, ARFCN, carrier) whether resources are on/off sync raster. In some examples, a subset of SSB/RS (e.g. SSB-a) may be transmitted on a carrier (e.g. perched carrier that may be located on sync raster), that may be different than the carrier (e.g. anchor carrier) where other subsets of SSB/RS (e.g. SSB-b) may be located. For example, UE in IDLE mode may locate SSB-a on the perched carrier (e.g. for sync) and relocate to SSB-b on the anchor carrier (e.g. for initial access).

For example, spatial domain resources may include a number of RS/beams in a burst, position of RS in a burst (e.g. bitmap), beamwidth of RS beams (e.g. wide-beams, narrow beams). Each RS config/sub-config may include resources which may or may not overlap with the resources in other RS configs/sub-configs, for example. In an example, the resources allocated for one or more RS configs/sub-configs may correspond to an RS resource pool.

For example, SSB/RS ports may include a number and set of Tx and/or Rx ports.

A resource type may correspond to the time-domain behavior of RS resource config which may be periodic, semi-persistent, aperiodic or on-demand (e.g. NW-triggered, UE-triggered).

Active SSB/RS resources in a burst, for an SSB config, this parameter may indicate the SSB positions in a burst. The active SSBs in a burst (index of SSBs that are transmitted) may be indicated via bitmap with different lengths, e.g. bitmap length of 4 bits may be used for FR1 when there may be 4 SSBs in a burst. Bit ‘1’ may indicate an SSB is active/transmitted and bit ‘0’ may indicate the SSB is off.

A parameter relating to periodicity may, for an SSB config, indicate the periodicity of SSB bursts on a cell (e.g. 5 ms, 20 ms, 160 ms).

With respect to usage type, a WTRU may be configured with any of synchronization, cell (re)selection, initial access, paging (e.g. for IDLE mode), and/or beam management, RLM, NES, codebook/non-codebook, antenna switching for using such RS (e.g. for CONN mode).

Slot level periodicity and slot level offset are parameters that may be used, e.g., for periodic or semi-persistent RS. The parameters may include parameters related to or associated with SSB/RS resource/beam bandwidth.

Frequency hopping information may include a WTRU being configured with one or more hopping patterns that may be applied over a set of RS resources in any of the time, frequency, and spatial domains. In a hopping pattern, the RS resources (e.g. for SSB-a, SSB-b) may be located in time and/or frequency location, where the resource may or may not overlap in time and frequency domains (e.g. SSB-b may be at frequency F1 and F2 in time T1, at frequency F1 at time T2, at frequence F1 and F2 at T3, . . . ). In a hopping pattern, a partial set of RS resources in frequency domain (e.g. PRBs) may be used in each time domain resource (e.g. symbol) for transmitting/receiving the RS using different spatial relation. Such hopping pattern may correspond to one or more NES adaptation/state, for example.

A parameter relating to guard period may include or indicate number of symbols/slots/ms. A WTRU may apply the guard period when switching between different RS configs/sub-configs or when switching between different Rx ports for the RS reception.

SSB/RS comb pattern information may include a parameter that may include transmission comb value, which may be associated with the gap in terms of the number of PRBs or number of symbols/slots between two RS resources in the frequency and/or time domains. Each RS config may include one or more RS comb patterns, where each pattern may be associated different set of parameters (e.g. offset value, cyclic shift) and/or RS resources in time/frequency/spatial domains. A comb pattern may include RS resource in different symbols (within one slot or across multiple slots) or slots, where the RS in different symbols/slots may be received with different spatial relation/filter. When RS is configured with periodic or semi-persistent RS resources, the RS comb pattern (e.g. using resources in time, frequency, spatial domains) may be repeated in each period. When RS is configured with aperiodic RS resources, the RS burst may consist of RS resources in time, frequency, spatial domains.

In some examples, a WTRU may be indicated a parameter relating to comb offset hopping pattern with repetition.

Sync signals may include the sequences used (e.g. m-sequence, Zadoff-Chu sequence) for the sync signals in SSB-a may be the same or different than the sequences in the sync signals of SSB-b. In an example, the sequences used for sync signals in SSB-a may be of a different format (e.g. short format) than those in SSB-b (e.g. long format), e.g., possibly to enable fast synchronization. The resources (e.g. in terms of number of subcarriers and/or symbols) used for the sync signals in SSB-a may be lower/higher compared to the resources used for the sync signals in SSB-b.

Beam Tx power may include the Tx power applied per RS signal/resource/beam/burst (e.g. SS-PBCH-Block power).

Power control parameters may include any of alpha, p0, pathloss reference RS, power per RB block, and RS power control adjustment states (e.g. closed loop factor).

A reference beam may include or indicate index/ID of an SSB/RS beam (e.g. SSB, CSI-RS, TRS) that may be predefined, preconfigured or indicated to serve as a reference beam, possibly for determining any of the power offset/adjustment and RSRP/RSRQ/pathloss thresholds. A set of SSB/RS beams (e.g. in a burst, period, pool, config, cell) may be associated with at least one reference beam. A reference beam may be configured to located within an SSB burst (e.g. one SSB out of K SSBs in a burst) or may be outside of a burst (e.g. separate signal outside of an SSB burst). In an example, the reference beam may be transmitted with a peak Tx power. In an example, the reference beam may serve as a QCL source for the other associated beams.

In certain embodiments, a WTRU may receive, in configuration information, the following events, conditions and/or threshold values for selecting or using any of the SSB configs/sub-configs, and SSB resources: measurement threshold values, timing information, transmission/reception power, and/or priority.

The measurement threshold values, or threshold values, may correspond to any of EPRE, RSRP, RSRQ, SINR, CQI, pathloss, etc. For example, the WTRU may select an RS (e.g. an SSB-a beam as a pathloss RS), when the measurements made on an associated RS is higher/lower than a RSRP threshold. The threshold values may be configured/indicated based on any of a per RS/beam, per burst, and per config/sub-config.

Timing information may include any of: a start time threshold (e.g., an RS resource/beam may be received if it begins no later than a start time of T1 symbols/slots/ms after the UE receives an indication associated with activation of the RS config to which the RS resource belongs), an end time threshold (e.g., an RS resource/beam may be received if it ends no earlier than an end time of T2 symbols/slots/ms after the UE receives an indication associated with deactivation of the RS config to which the RS resource belongs), and/or time window (e.g. start offset time, length. For example, the UE may use one or more RS configs that may be accommodated within the time window for RS transmission).

The transmission (Tx)/reception (Rx) power may include any of a Tx power threshold (for example, the UE may use one or more RS resources (e.g. in time domain and/or frequency domain) if the receive power (e.g. total power in RS resources in a transmission instance) is less than a first power threshold value and/or greater than a second power threshold value), and/or power spectral density (PSD) threshold. For example, the UE may use one or more RS resources (e.g. in time domain and/or frequency domain) if the PSD over the RS resources is less than a first PSD threshold value and/or greater than a second PSD threshold value.

The priority may include one or more priority values that may be associated with any of RS configs, RS resources, and RS parameters. For example, the UE may use an RS config, when the priority associated with the RS config is higher than a priority threshold value and/or lower than another priority threshold value.

Any of the configurations, parameters, and/or example embodiments described above and elsewhere herein are applicable in other embodiments described herein.

In an embodiment, the WTRU may receive configurations and/or sub-configurations associated with one or more cells in a multi-cell deployment. Such configuration info may include any of the following: configuration(s) associated with a coverage and/or anchor cell (e.g., Cell A) and/or configuration(s) associated with a NES cell.

With respect to configuration(s) associated with a Coverage/Anchor Cell (Cell A), Cell A may provide wider coverage (e.g. One or more NES cells may be overlaid over a Cell A). Cell A may transmit both SSB-a (e.g. short periodicity) and always-on SSB-b (e.g. long periodicity). Additional SSB-a/SSB-b may be transmitted by Cell A on on-demand basis. Any of the SSBs and/or NES-RRS may be transmitted in wide beams (e.g. when operating is NES mode) or in narrow beams (e.g. during high load conditions). A WTRU may receive the UL-WUS config for one or more NES Cells or Cell A in any of the RS (e.g. SSB-a) of Cell A.

With respect to configuration(s) associated with an NES cell, a NES Cell may provide limited coverage (e.g. optimized for capacity and energy savings). A NES Cell may transmit SSB-a with short/long/adaptable periodicity both as always-on RS or as on-demand RS. A NES Cell may transmit SSB-b with long periodicity (typical) as always-on RS or as on-demand RS. A NES Cell may transmit sync signals, light PBCH, SSB-a to support time/frequency synchronization, cell measurements, cell (re)selection, paging, initial access, etc., possibly for IDLE mode operation. A NES Cell may transmit sync signal (e.g. SSB-a), NES-RS (e.g. OD-SSB), SSB-b, measurement RS (e.g. CSI-RS) to support time/frequency synchronization, RRM, RLM/BM, etc., possibly for CONN mode operation. A WTRU may receive the SSBs/RSs in or out of sync raster. For example, the WTRU may receive the SSBs on ARFCN channels that may be known to the WTRU or dynamically indicated to WTRU. A WTRU may send an UL WUS signal to NES cell for requesting SSB-b/NES-RS/SIBx, possibly in scenarios when such RS/beams are not transmitted for transmitted with long periodicity.

In example embodiments described herein, the terms “NES Cell” and “small/capacity/micro cell” may be used interchangeably. Also, the terms “Coverage cell”, “Anchor Cell” and “Cell A” may be used interchangeably.

In some embodiments, a WTRU may determine to transmit a request for on-demand SSB-b transmissions. For example, the WTRU may determine to transmit the request for on-demand SSB-b transmissions based on predefined/preconfigured association information and/or information in SSB-a transmission. The WTRU may determine the locations of any of SSB-a, always-on SSB-b and/or on-demand SSB-b signals in time and/or frequency domains based on predefined/preconfigured information and information contained in or indicated by the SSBs. The WTRU may initially receive one or more SSB-a signals from a cell (e.g., network node). The WTRU may not receive the always-on SSB-b signals or may receive SSB-b signals with long periodicity from such a cell, possibly operating in an energy savings mode/state (e.g., NES state). A WTRU may be predefined or preconfigured with SSB-a configurations (e.g. first sync signal and a first PBCH), always-on and/or on-demand SSB-b configurations (e.g. second and possibly a third sync signal, second PBCH and/or MIB) and association information between SSB-a and SSB-b. The WTRU may determine the resources for requesting on-demand SSB-b transmissions based on the information in SSB-a signals. For example, such association info may be related to the properties (e.g. time/frequency locations, beams, periodicity) and/or inter-relationship between SSB-a and SSB-b signals. The WTRU may determine the time and/or frequency locations for receiving the on-demand SSB-b, e.g., based on the first PBCH received in SSB-a and/or the predefined association info between the SSBs.

In some embodiments, the UE may be predefined with and/or receive configuration information (e.g., parameters), from a NW, associated with the SSB-a, SSB-b and/or UL-WUS configurations or resources. Such predefinition or configuration info may be received, entirely or in one or more parts, in any of L3/RRC signalling (e.g. broadcast/SIB or dedicated signals), L2/MAC signaling (e.g. MAC CE) and/or L1/PDCCH (e.g. DCI, wake-up signalling) indications. Such information may include any of the combination of one or more of the following: set of SSB signals, parameters associated with one or more SSB-a configurations, parameters associated with one or more SSB-b configurations, association information indicating an association between SSB-a and SSB-b signals, UL-WUS configurations (e.g. UL-WUS resources), UL-WUS triggering conditions and/or criteria, CORESET/SS configuration(s), WUS response monitoring configuration, application time and/or delay, validity information associated RS configuration(s), and/or NES state and/or modes.

According to certain embodiments, a WTRU may be predefined and/or configured with one or more SSB signals (e.g. SSB-a, SSB-b) that may be grouped into one or more sets. Such set(s) may refer to any of a burst, period, cycle and config/sub-config. The parameters associated with SSBs (e.g. SSB-a, SSB-b) may include any of Ids/Index(es) of a set of SSBs in a burst, number of SSBs in a burst, position of SSB beams in burst (e.g. a bitmap may indicate which of the beams that are active/inactive in a burst), Sequences (e.g. id/index associated with sequence, format of sequence, time/frequency resources, which may be used for any of sync signals and PBCH DMRS of the SSB), resources in any of time, frequency and/or spatial domains, timing information including any of start offset, start/end symbol for set of SSBs, time duration/window during which SSBs are transmitted, time gap between a set of one or more SSBs within and across bursts. In an example, a WTRU may be configured with a first set of SSBs that may not be adapted (e.g. periodicity is not adapted, Tx power is constant) and a second set of SSBs that may be subject adaptation (e.g. adaptation of periodicity, adaptation of frequency location, adaptation of Tx power). In some examples, a set of SSBs may be associated with common properties or characteristics. Such common properties of the SSBs may include any of: time domain property (e.g. SSBs in a set are transmitted within an SFN and/or half-frame in a SSB burst, SSBs in a burst are transmitted with the same periodicity), frequency domain (e.g. SSBs in a set are transmitted within a min-max range of subcarriers and/or resource elements in a carrier), spatial domain property (e.g. number of beams in a burst per frequency range, share common QCL source, common QCL type), power domain property (e.g. Tx power of SSBs in a set is within a max-min power range), and/or resource type (e.g. periodic, semi-persistent, aperiodic, on-demand). For example, when any of the property/association for at least one of the SSBs in a set is changed/adapted, a similar change/adaptation may apply for one or more of the other SSBs bin the set.

In some embodiments, a WTRU may be predefined/configured with one or more of the following parameters associated with SSB-a: Index/ID (e.g. index per SSB-a config), periodicity of SSB-a (e.g. periodicity per set, per burst or per signal/beam), periodicity of a subset of SSB-a signals containing first PBCH (e.g. periodicity per burst or per signal/beam), reference SFN (e.g. SFN #0 per SSB-a config), frequency location (e.g. location of start/center frequency of the RBs associated with SSB-a on/off sync raster), sequence used in the RS resources associated with SSB-a (e.g. m-sequence, Zadoff-Chu sequence), cell ID (e.g. the PCI of the cell transmitting SSB-a may be encoded/scrambled/included in any of the sequences or signals transmitted by the cell including first sync signals, first PBCH, PBCH DMRS), and/or Tx power of SSB-a signals/beams/resources (e.g. indexes to one or more power levels, power offset values with respect to a reference/max/min power levels).

SSB-a may include at least a sync signal (e.g. first sync signal). The first sync signal may be different from those in SSB-b (e.g. format, limited sequence length, limited resources), e.g. possibly to enable fast measurements related to synchronization. The first sync signals may be scrambled with one or more scrambling sequences. For example, the first sync signal in an SSB-a received in a first time period (e.g. SFN #1) may be scrambled with a first scrambling sequence and the first sync signal in an SSB-a received in a second time period (e.g. SFN #3) may be scrambled with a second scrambling sequence. Such scrambling sequences may be associated with the SFN values in which the SSB-a may be transmitted, for example.

In some examples, SSB-a may correspond to low power synchronization signals (LP-SS), that may be received by the UE in a low power receiver. The WTRU may wake up the main radio in UE when detecting SSB-a with the LP receiver, for example. SSB-a signals may not be typically transmitted in all SFNs, subframes or slots but may be transmitted in a set of SFNs/subframes (e.g. SFNs with even or odd index values).

At least a subset of SSB-a signals (e.g. in some time/frequency locations) may include a first PBCH. The first PBCH may include a PBCH DMRS (e.g. sequence) and payload. In some examples, for a set of SSB-a signals transmitted with periodicity P1, a subset of SSB-a signals containing light PBCH (e.g. PBCH DMRS and payload) may be transmitted with P2 (e.g. P2 >P1). The first PBCH (e.g. DMRS associated with first PBCH) may be scrambled with one or more scrambling sequences. For example, the first PBCH in an SSB-a received in a first time period (e.g. SFN #1) may be scrambled with a first scrambling sequence and the first PBCH in an SSB-a received in a second time period (e.g. SFN #3) may be scrambled with a second scrambling sequence. Such scrambling sequences may be associated with the SFN values in which the SSB-a may be transmitted, for example.

The first PBCH may be referred to herein as light PCBH and may contain less information then a second PBCH. The term ‘light PBCH’ is for example purposes only and other terminology may be used to refer this first type of light PBCH. Any two PBCHs transmitted or received that carry different information may be used and still be consistent with the examples of the embodiments described herein.

A WTRU may be configured with one or more SSB-a configurations (i.e., configs), where each config may be associated with different index/ID and properties in any of time domain (e.g. periodicity, start offset, reference SFN), frequency domain (e.g. location on sync raster, carrier, offset from a reference frequency location), spatial domain (e.g. number of SSB-a beams of burst) and power domain (e.g. Tx power per SSB-a signal/beam). One or more of the SSB-a configs may be associated with always-on SSB-a transmissions (e.g. periodic SSB-a transmissions with a fixed periodicity) and other SSB-a configs may be associated with on-demand SSB-a transmissions (e.g. semi-persistent or aperiodic SSB-a transmissions over a time window).

In some embodiments, a WTRU may be predefined/configured with the following parameters associated with SSB-b: Index/ID (e.g. index per SSB-b config), periodicity of SSB-b (e.g. periodicity per set, per burst or per signal/beam), periodicity of a subset of SSB-a signals containing second PBCH (e.g. periodicity per set per burst or per signal/beam), reference SFN (e.g. SFN #0 per SSB-b config), frequency location (e.g. location of start/center frequency of the RBs associated with SSB-b on/off sync raster), cell index/ID (e.g. the PCI of the cell transmitting SSB-b may be encoded/scrambled/included in any of the sequences or signals transmitted by the cell including second/third sync signals, second PBCH, PBCH DMRS), sequence used in the RS resources associated with SSB-b (e.g. m-sequence, Zadoff-Chu sequence), and/or Tx power of SSB-b signals/beams/resources (e.g. indexes to one or more power levels, power offset values with respect to a reference/max/min power levels).

SSB-b signals may include any of one or more sync signals (e.g. second and third sync signals, PSS/SSS), a MIB, PBCH (e.g. DMRS, payload). The second/third sync signals may be scrambled with one or more scrambling sequences. For example, the second/third sync signal in an SSB-b received in a first time period (e.g. SFN #1) may be scrambled with a first scrambling sequence and the second/third sync signal in an SSB-a received in a second time period (e.g. SFN #3) may be scrambled with a second scrambling sequence. Such scrambling sequences may be associated with the SFN values in which the SSB-b or an associated SSB-a may be transmitted, for example.

SSB-b signals may not be typically transmitted in all SFNs, subframes or slots but may be transmitted in a subset of SFNs/subframes (e.g. SFNs with even or odd index values). In some examples, SSB-b may be transmitted in a subset of SFNs where SSB-a may be transmitted. In another example, SSB-b may be transmitted in a subset of SFNs where SSB-a may be transmitted with a time offset value (e.g. if SSB-a is transmitted in SFN #K, SSB-b is transmitted in SFN #K+offset). At least a subset of SSB-b signals may have system information (e.g. SIB1) that may be transmitted or received with the SSB-a signals or in other associated signals/channels (e.g. PDCCH/PDSCH).

At least a subset of SSB-b signals (e.g. in some time/frequency locations) may include a second PBCH. The second PBCH may include a PBCH DMRS (e.g. sequence) and a payload. In examples, the payload may contain and/or may be associated with other signals/channels containing one or more SI, including any of cell selection info, RACH config, serving cell config. In examples, for a set of SSB-b signals transmitted with periodicity P3, the subset of SSB-b signals that may be associated with SI #a and SI #b may be transmitted with periodicity P4 and P5, respectively (e.g. P4>P3, P5>P3). The second PBCH (e.g. DMRS associated with the second PBCH) may be scrambled with one or more scrambling sequences. For example, the second PBCH in an SSB-b received in a first time period (e.g. SFN #1) may be scrambled with a first scrambling sequence and the second PBCH in an SSB-b received in a second time period (e.g. SFN #3) may be scrambled with a second scrambling sequence. Such scrambling sequences may be associated with the SFN values in which the SSB-b or an associated SSB-a may be transmitted, for example.

According to some embodiments, a WTRU may be configured with one or more SSB-b configs, where each config may be associated with different index/ID and properties of SSB-a in any of time domain (e.g. periodicity, start offset, reference SFN), frequency domain (e.g. location on sync raster, carrier, offset from a reference frequency location), spatial domain (e.g. number of SSB-b beams of burst) and power domain (e.g. Tx power per SSB-b signal/beam). One or more of the SSB-b configs may be associated with always-on SSB-b transmissions (e.g. periodic SSB-b transmissions with a fixed periodicity) and other SSB-b configs may be associated with on-demand SSB-b transmissions (e.g. semi-persistent or aperiodic SSB-b transmissions over a time window).

In certain embodiments, association information between SSB-a and SSB-b signals may include any of the following: periodicity relation, duration relation, UL-WUS resources/configs, control resource set (CORESET) associated with SSB-a/SSB-b, periodicity of a search space (SS), multiplexing pattern, timing relation, frequency relation, spatial relation, UL-WUS triggering conditions and/or criteria, CORESET or SS configuration(s), WUS response monitoring configuration(s), application time and/or delay, validity information associated RS configuration(s), and/or NES state and/or modes.

Periodicity relation may include periodicity of SSB-b transmissions (e.g. always-on and/or on-demand) being associated with the periodicity of SSB-a transmissions based on a scaling factor y (e.g. y>=1). When SSB-b contains or associated with a signal (e.g. second sync signal, MIB, second PBCH) or a particular SI (e.g. SIB1), the scaling factor may be adjusted as y*i, where i may be associated with the signal or the SI. In this case, different SI may be associated with different i value, for example. In some examples, the periodicity of SSB-b transmissions may be associated with other properties of SSB-a based on different scaling factor values, including those associated with the TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point). For example, periodicity of SSB-b may be determined based on the index of scrambling sequence used for scrambling the first sync signal of SSB-a and an associated scaling factor value.

Duration relation may include a duration of on-demand SSB-b transmissions (e.g. in terms of number of SSB-b bursts, number of SFNs/subframes, ms) being associated with the periodicity of SSB-a transmissions based on a scaling factor z (e.g. z>=1). In some examples, the duration of on-demand SSB-b transmissions may be associated with other properties of SSB-a based on different scaling factor values, including those associated with the TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point). For example, the duration of OD-SSB-b may be determined based on the index of scrambling sequence used for scrambling the first sync signal of SSB-a and an associated scaling factor value.

In some embodiments, a WTRU may be predefined/preconfigured with one or more UL-WUS configurations or resources, which may include any of sequences/preambles (e.g. PRACH preambles, preamble formats), WUS occasions in time, frequency domains and spatial domains (e.g. WUS/RACH occasions in time and frequency domains, beams associated with UL-WUS transmission). Such UL-WUS resources/sequences may be cell-specific (different sequences/preambles may be used for transmitting to different cells or for requesting OD-SSB-b from different cells), SSB-a signal specific (e.g. different sequences/preambles may be used for different SSB-a signals/beams) or SSB-b specific (e.g. different sequences/preambles may be used for requesting indicating different OD-SSB-a configs/signals/beams). Such UL-WUS resources may be device type specific (e.g. including any of eMBB device, low power wide area (LPWA) device, narrow-band IoT device, XR device) or device capability specific (e.g. capability in terms of active number of Tx/Rx antennas, Tx power level, battery capacity level). Such UL-WUS resources may be coverage-specific or radio conditions specific. Such UL-WUS resources may be data QoS specific (e.g. low QoS, high QoS, guaranteed bit-rate, URLLC, XR). For example, the WTRU may be configured with one or more UL-WUS resources (e. g preambles, sequences, WUS/RACH occasions in time/frequency/spatial domains) along with association information for associating the UL-WUS resources with any of the one or more properties including cell-type, SSB-type, device type, device capability, radio conditions and data QoS. In an example, the association information configured/received by the WTRU may indicate the association between M SSB-a beams and N UL-WUS resources (e.g. WUS occasions in time/frequency domain), where the N UL-WUS resources may be associated with the K properties. The WTRU may select a UL-WUS resource, possibly from a pool of UL-WUS resources (e.g. N UL-WUS resources associated with a selected SSB-a beam), based on the associated property when transmitting the UL-WUS. The transmisison of UL-WUS using such associated resource may indicate to network the associated property. Alternatively, transmisison of an UL-WUS indication using such associated resource may indicate a request to the NW for a particular on-demand SSB configuration (e.g. long/short periodicity, long/short transmisison duration, high/low Tx power) possibly known to the WTRU based on the association information, where the on-demand SSB configuration that may be suitable for the WTRU or a property associated with the WTRU (e.g. device type, device capability, coverage condition). Based on such indication in the UL-WUS, the WTRU may expect a WUS response indication and/or a on-demand SSB transmisison that may be associated with the indicated property, for example.

Such WUS occasions may correspond to the time/frequency locations where the cell may be receiving the UL transmitted UL-WUS resources, for example. Such UL-WUS resources may be associated with the properties of the SSB-a signals, including any of periodicity, TD/FD resources of SSB-a (e.g. number of symbols, number of RBs), scrambling sequence/code used in the first sync signal or first PBCH of SSB-a (e.g. index of sequence), and time/frequency offset of SSB-a (e.g. relative to a reference point). The WTRU may be predefined/preconfigured with one or more association info between the UL-WUS resource and the properties of SSB-a signals. For example, the WTRU may determine the UL-WUS resource to transmit based on the determined of the SSB-a and association information between the UL-WUS resource and SSB-a periodicity. In an example, the association information may indicate whether any of the UL-WUS configuration/resources are provided with SSB-a signals/beams (e.g. in first PBCH) and/or with SSB-b signals/beams (e.g. in second PBCH).

According to certain embodiments, a WTRU may be predefined/configured with one or more control resource sets (CORESETs) or PDCCH monitoring configs where the control indications associated with any of SSB-a and SSB-b may be received (e.g., CORESET is associated with SSB-a and/or SSB-b). For example, the WTRU may switch between a first CORESET/PDCCH monitoring configuration associated with an SSB-a config and a second CORESET/PDCCH monitoring configuration associated with an SSB-b config, possibly for receiving any control indications (e.g. DCI) associated with SSB-a and SSB-b signals.

Periodicity of a search space (e.g., indicated by a PDCCH common search space configuration in a MIB included in an SSB-b transmission) for receiving PDCCH associated with one or more SI (e.g., a target SI) may be associated with the periodicity of the SSB-a or the SSB-b transmissions, e.g., based on a scaling factor z. In some examples, periodicity of SS (SS) for receiving PDCCH associated with each of one or more target SI (e.g. SI1, SI2) may be associated with a different scaling factor value (e.g. z1, z2). For example, the scaling factor for the periodicity of SS for receiving PDCCH associated with SI1=z1, scaling factor for the periodicity of SS for receiving PDCCH associated with SI2=z2.

A multiplexing pattern may indicate N SSB-a transmissions may be followed by M SSB-b transmissions (e.g. always-on or on-demand), possibly within a time window or period. Different multiplexing patterns may be associated with different properties of SSB-a and/or SSB-b (e.g. index, periodicity, etc.).

In some embodiments, the timing relation between SSB-a and SSB-b (e.g. always-on and/or on-demand SSB-b) may be indicate whether SSB-a and SSB-b signals are transmitted with the same or different pattern. For example, the association info may indicate both SSB-a and SSB-b are transmitted in either even or odd numbered SFNs. In this case, a subset of the even/odd SFNs that contain SSB-a may also contain SSB-b, for example. A timing relation between SSB-a and SSB-b may be associated with a time offset. The time offset for SSB-b relative to SSB-a or a reference time point (e.g. in units of SFNs, subframes, symbols, ms) may be associated with properties of SSB-a based on different scaling factor values, including those associated with the periodicity of SSB-a, TD/FD resources of SSB-a (e.g. number of symbols, number of RBs), scrambling code/sequence used in the first sync signal or first PBCH of SSB-a (e.g. index of sequence), and time/frequency offset of SSB-a (e.g. relative to a reference point). For example, the time offset of an SSB-b signal (relative to an SSB-a signal) may be determined based on the periodicity of SSB-a and a time offset scaling value. For example, the time offset of an SSB-b signal (relative to an SSB-a signal) may be determined based on the scrambling code/sequence used in the first PBCH of SSB-a. The scrambling code in first PBCH of SSB-a may indicate the number of time periods (e.g. SFNs) to the nearest SSB-b from the SSB-a. In some examples, timing relation info may be provided as a time offset/gap between the last symbol/slot of an SSB-a signal/beam in a burst and the first symbol/slot of the first of N SSB-b beams in a burst. For example, the timing of an SSB-a signal/beam (e.g. last symbol/slot of an SSB-a beam in a burst of an SSB-a config) may be T1 and the timing of the SSB-b beam (e.g. first symbol/slot of the first SSB-b beam in a burst of an SSB-b config) may be T2=T1+time offset.

A frequency relation between SSB-a and SSB-b (e.g. always-on and/or on-demand SSB-b) may be associated with a frequency offset. Frequency offset for SSB-b relative to SSB-a or a reference frequency location point (e.g. in units of subcarriers, carriers, resource elements, resource blocks, Hz) may be associated with properties of SSB-a based on different scaling factor values, including those associated with the periodicity of SSB-a, TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point). For example, the frequence offset of an SSB-b signal (relative to an SSB-a signal) may be determined based on the periodicity of SSB-a and a frequency offset scaling value.

Spatial relation for SSB-b beams relative to SSB-a beams (e.g. in terms of number of beams per burst) may be associated with properties of SSB-a based on different scaling factor values, including those associated with the number of SSB-a beams in a burst, the periodicity of SSB-a, TD/FD resources of SSB-a (e.g. number of symbols, number of RBs), scrambling sequence used in the first sync signal or first PBCH of SSB-a (e.g. index of sequence), and time/frequency offset of SSB-a (e.g. relative to a reference point). For example, the number of SSB-b beams in a burst may be determined based on the number of SSB-a beams in a burst and a beam number scaling factor b (e.g. b>=1). In some examples, one (wide beamwidth) SSB-a beam may be associated with N (narrow beamwidth) SSB-b beams. QCL info between the beams in SSB-a and SSB-b may be provided as a mapping relation between an id/index of SSB-a beams and id/indexes of SSB-b beams. For example, an SSB-a beam with index i may be associated with a set of SSB-b beams with indexes {a, b, c, d, e}. In this case, the set of SSB-b beams {a, b, c, d, e} may fall within the beamwidth or coverage of SSB-a beam i and/or may be transmitted from the same/similar set of antenna elements/ports/panels at the cell. The WTRU may use the same/similar spatial relation (e.g. spatial Rx filter) for receiving both SSB-a beam i and any beams within the set of SSB-b beams {a, b, c, d, e}.

The conditions or criteria for triggering UL-WUS transmission, which may be monitored by a WTRU, may include any of the following: RSRP/RSRQ/energy measurements of one or more SSB-a signals are less than a threshold and/or higher than a threshold, time gap (e.g. in terms of SFNs, subframes, slots, symbols, ms) to the nearest always-on SSB-b signal (e.g. containing MIB/SI) is greater than a threshold and/or less than a threshold, frequency location of always-on SSB-b signals is greater than a threshold and/or less than a threshold, no other on-demand SSB-b transmissions are received or expected to be received in one or more time/frequency/spatial locations and/or within a duration/window, and/or no other UL-WUS response indication is received in the associated CORESET within a monitoring duration/window, possibly in a WUS response monitoring config/resources.

According to some embodiments, a WTRU may be predefined and/or configured with a CORESET/SS config. For example, the WTRU may be predefined/configured with one or more resources in any of time, frequency, spatial and code domains for receiving any of group-common, cell-common, or UE-dedicated indications in PDCCH. Such resources may be associated with a CORESET and/or a SS (e.g. common SS), which may be associated with an initial bandwidth part, which may be monitored by the UE with a certain configured periodicity and/or a duration. Such CORESET and/or SS may be associated with CORESET0 and/or SS0 (common search space), which may be used for receiving a common PDCCH from the network. Such CORESET and/or SS may be associated with one or more multiplexing patterns which may indicate how the monitoring resources in which a PDCCH may be received may be multiplexed with SSB-a signals (e.g. in TD/FD). The WTRU may be configured with one or more parameters associated with CORESET/SS config including index (e.g. index of WUS monitoring config), periodicity, and time/frequency resource offset (e.g. with respect to a reference point in time/frequency).

In certain embodiments, a WTRU may be predefined and/or configured with a WUS response monitoring configuration. For example, the WTRU may be predefined/configured with one or more resources in any of time, frequency, spatial and code domains for receiving a WUS response indications from NW, possibly upon transmitting an UL-WUS indication. Such resources may be associated with a CORESET and/or a search space (SS), which may be associated with an initial bandwidth part, which may be monitored by the UE with a certain configured periodicity and/or a duration, possibly upon transmitting UL-WUS. Such CORESET and/or SS may be associated with CORESET0 and/or SS0 (common search space), which may be used for receiving a common PDCCH from the network. Such CORESET and/or SS may be associated with one or more multiplexing patterns which may indicate how the monitoring resources in which WUS response may be received may be multiplexed with SSB-a signals (e.g. in TD/FD). The WTRU may be configured with one or more parameters associated with WUS response monitoring config including index (e.g. index of WUS monitoring config), periodicity, WUS response window duration (e.g. for monitoring WUS response), time/frequency resource offset (e.g. with respect to a reference point in time/frequency) and start offset (e.g. with respect to a reference time point such as start of window, end of window, UL-WUS transmission time).

According to some embodiments, a WTRU may be configured with one or more application time/delay values, which may indicate a time duration starting with the time instance (e.g. symbol/slot) from the reception of an indication indicating the start/triggering of the SSB-a/SSB-b signals/beams (e.g. always-on and/or on-demand) to the time instance when the SSB-a/SSB-b signals/beams are actually transmitted or received. In examples, the application time for SSB-a may be the same or different than those of SSB-b.

In certain embodiments, a WTRU may be configured with a validity info associated with the SSB-a and SSB-b configs. Such validity info may be associated with any of time and location attributes. For example, a time validity may indicate the time duration (e.g. in terms of SFNs, symbols, slots) during which any of the SSB-a and SSB-b configs may be assumed to be valid. After the end/expiry of the time duration, the UE may assume the SSBs associated with the SSB-a and SSB-b configs are no longer available/valid. In another example, a location validity may indicate the coverage area or location, possibly that associated with WTRU location and/or cell ID, in which any of the SSB-a and SSB-b configs may be assumed to be valid. Outside of the location validity, the WTRU may assume the SSBs associated with the SSB-a and SSB-b configs are no longer available/valid, for example.

According to some embodiments, a WTRU may be configured with association info between NES states/modes and the corresponding SSB-a and SSB-b configs. For example, when configured with cell DTX config, consisting of a set of periodically occurring active and non-active periods, the WTRU may assume SSB-a signals may be available during the cell DTX non-active periods or when cell DTX is deactivated, and the SSB-b signals may be available only during the cell DTX active periods. In another example, the WTRU may assume SSB-a signals may be available regardless of cell DTX periods and SSB-b signals (e.g. always-on and on-demand) may be available only during cell DTX active periods. Alternatively or additionally, the SSB-a signals may be available in a first group of symbols/slots/periods associated with cell DTX and the SSB-b may be available in a second group of symbols/slots/periods associated with cell DTX, for example.

In some embodiments described herein, a WTRU may receive one or more signals of an SSB-a (e.g., from a cell or network node). Such SSB-a signals may be associated with an active SSB-a configuration. According to certain embodiments, Such SSB-a signals may be received by a WTRU, for example, during any of the following: power on, when supporting any functions associated with IDLE mode (e.g. cell (re)selection, synchronization, SI update, paging), and/or when supporting functions associated with CONNECTED mode (e.g. L1/L3 measurements, RLM, BM).

In typical scenarios, the WTRU may receive SSB-a signals before SSB-b signals. Such scenarios may be applicable when SSB-a signals may be transmitted or received more frequently than SSB-b (e.g. periodicity of SSB-b is longer than that of SSB-a). Another scenario is when SSB-a may be located in the frequency domain on the sync raster carriers or initial/start-up carriers (e.g. perched carriers), which may be preconfigured/predefined in the WTRU. The SSB-b may be located on a different carrier (e.g. anchor carrier) that may not be known to the WTRU in advance. In some scenarios, where both SSB-a and SSB-b may be located on the same carriers, the WTRU may receive at least one transmission of SSB-b, possibly before receiving SSB-a signals. In this case, the WTRU may achieve synchronization with one or more SSB-b signals without SSB-a signals and may perform other idle mode functions (e.g. cell selection, initial access) based on the MIB/SI received in association with SSB-b. Otherwise, the WTRU may first receive SSB-a signals (for synchronization and locating SSB-b signals) before receiving the MIB/SI in SSB-b signals.

The SSB-a signals received by the WTRU may contain a first sync signal and a first PBCH (e.g., light PBCH). The first PBCH may include PBCH DMRS and payload (e.g. N1 bits). The WTRU may achieve synchronization with a cell transmitting SSB-a signals based on detection and/or reception of the first sync signals in one or more SSB-a signals.

The first PBCH in an SSB-a signal (e.g. first PBCH payload) may indicate any of the following: SFN, indication of SSB-a config, indication of always-on SSB-b config, association between SSB-a and SSB-b config, scaling factor value for the periodicity of an SSB-b (e.g. always-on and/or on-demand SSB-b), scaling factor value for the duration of on demand SSB-b, scaling factor value for the periodicity of the SS for receiving PDCCH (e.g., configured in the PDCCH configuration in MIB of SSB-b) associated with receiving of an SI (e.g., a target SI), indication of UL-WUS configuration (e.g. UL-WUS resources, flag/indication on whether UL-WUS resources are provided in the signals/channels associated with SSB-a and/or with SSB-b), indication of WUS response monitoring config (e.g. time/frequency/code resource set, CORESET, search space), indication of CORESET/search space (SS) config, indication of priority, time location of SSB-b, frequency location of SSB-b, Tx power parameters, indication of on-demand SSB-b triggering, and/or signalling indicating the activation/deactivation of NES adaptations/states. In an example, the WTRU may receive an indication/flag, possibly in the first PBCH indicating that the UL-WUS configuration is available via one or more or a subset of SSB-a siganals/beams. In another example, the WTRU may receive an indication/flag (e.g. in first PBCH) indicating that the UL-WUS configuration is not available via SSB-a. In this case, the WTRU may assume the UL-WUS resource configuration may be received via one or more or a subset of SSB-b signals/beams (e.g. in a PDCCH/PDSCH or SI associated with SSB-b). In the case, if any of the indication/flag associated with UL-WUS configurations is not received in SSB-a (e.g. first PBCH) or SSB-b (e.g. second PBCH, PDCCH/PDSCH), the WTRU may assume any of the following: UL-WUS transmission is not supported in the cell, WTRU may use a predefined/preconfigured UL-WUS configuration (e.g. if valid configuration is available), access another cell or another SSB-b signal/beam (e.g. if not indicated in SSB-a signal/beam), and access another SSB-a/SSB-b signal/beam after a certain preconfigured duration (e.g. if configured with a prohibit timer).

A SFN may include, e.g., n bits for indicating the SFN value where SSB-a is located. An indication of SSB-a config (e.g. indicating ids/indexes) may be associated with any of the one of more of predefined/preconfigured SSB-a configs that may be active. An indication of always-on SSB-b config (e.g. indicating ids/indexes) may be associated with any of the predefined/preconfigured SSB-b configs. For example, the indication may indicate the always on SSB-b configs that may be associated with the SSB-a. For example, different SSB-b configs may be associated with different sets of parameters (e.g. periodicity, number of beams in burst, etc.). The indication may indicate of at least one of the preconfigured SSB-b configs that may be active, for example. An association between SSB-a and SSB-b config, for example, may indicate an index/id of the association between SSB-a and SSB-b.

A scaling factor value for the periodicity of an SSB-b (e.g. always-on and/or on-demand SSB-b) may, e.g., may indicate the periodicity of SSB-b is 2× the periodicity of SSB-a. A scaling factor value for the duration of on demand SSB-b, e.g., may indicate the duration of OD-SSB-b (e.g. in terms of N number of bursts, ms) is K multiple of the periodicity of SSB-a (e.g. where K <1 and K>=1). A scaling factor value for the periodicity of the SS for receiving PDCCH (e.g., configured in the PDCCH configuration in MIB of SSB-b) associated with receiving of an SI (e.g., a target SI), e.g., may indicate the periodicity of the SS (for receiving PDCCH) associated with an SI may be 4× the reference periodicity which may be that of the SSB-a or SSB-b. For example, for M number of SI that may be included in SSB-b (e.g. different bitfields of MIB/PBCH payload of SSB-b) or in a signal/channel associated with SSB-b (e.g. PDCCH/PDSCH), the first PBCH may indicate M scaling factor values (explicitly or implicitly).

An indication of UL-WUS configuration may indicate an index to a predefined/preconfigured UL-WUS configuration (e.g. UL-WUS resources). In an example, a UL-WUS configuration may be implicitly indicated based on presence of a bit (e.g. value ‘1’) in a bitfield which may indicate allocation of UL-WUS resource and the association between the UL-WUS configuration and a property of SSB-b (e.g. periodicity of SSB-a). For example, 2 bits in a bitfield may indicate one of 4 UL-WUS configurations which may be associated with the periodicity of SSB-a. In an example, the UL-WUS triggering conditions/criteria may be indicated as an index (e.g. to a preconfigured criteria or set of conditions) and threshold values. The indication may indicate the validity of UL-WUS configuration, including time validity (e.g. timer value or a time duration from a reference where the UL-WUS config may be assumed to be valid) and spatial validity (e.g. list of cells/PCIs where the UL-WUS config may be assumed to be valid). The indication may indicate whether the resources in the UL-WUS config may be associated with any of periodic, semi-persistent (e.g. periodic over a time duration/window) or aperiodic resources.

An indication of WUS response monitoring config (e.g. time/frequency/code resource set, CORESET, search space) may indicate an index to a predefined/preconfigured WUS monitoring config, may indicate any of resources in time, frequency, spatial and code domain for monitoring and receiving one or more WUS response indications, e.g. upon transmitting an UL-WUS indication, and/or may indicate the parameters associated with CORESET and SS, including one or more CORESET multiplexing patterns (e.g. multiplexing in TD/FD between SSB-a and resources in which WUS response may be received). For example, 2 bits for indicating one of 4 different monitoring configs or CORESET multiplexing patterns.

An indication of CORESET/search space (SS) config may indicate an index/ID to a predefined/preconfigured configuration/resources associated with CORESET and/or search space (e.g. CORESET0 or SS0). Such CORESET/SS config may be associated with a common set of resources (e.g. in any of time, frequency, spatial and code domains) which the UE may monitor for receiving any or group-common, cell-common or WTRU-dedicated indications (e.g. DCI), possibly in PDCCH. Such CORESET/SS config may be associated with one or more properties of SSB-a (e.g. index, periodicity, symbol duration, scrambling code in first PBCH), which may be used by the UE for determining the corresponding CORESET/SS config.

An indication of priority may indicate the priority value associated with one or more SSB-b configs, including always-on SSB-b and on-demand SSB-b configs. In an example, when any of the SSB-b signals associated with different always-on SSB-b and on-demand SSB-b configs overlap in any of time, frequency or spatial domains, the WTRU may use the indicated priority value for determining which of the SSB-b signals to be selected and/or used, e.g. for measurements, cell (re)selection, initial access, etc. In this case, the WTRU may select the SSB-b signals associated with the SSB-b config with the highest priority, for example. In an example, when signals associated with both on-demand SSB-b and always-on SSB-b are received by the WTRU and when any of the associated SSB-b signals overlap in any of time, frequency or spatial domains, the WTRU may prioritize using the SSB-b signals associated with on-demand SSB-b (e.g. for measurements), possibly when the priority is not indicated.

A time location of SSB-b, e.g., may indicate the absolute time location (e.g. SFN) or a relative time location of an SSB-b (e.g. next/nearest SSB-b signal of always-on or on-demand SSB-b) in terms of a time offset relative to the time location of SSB-a or a reference time point. Such time offset may be indicated in units of SFNs, subframes, slots, symbols, and ms. In an example, the time offset for SSB-b (e.g. time period, possibly in terms of SFNs, when SSB-b is transmitted relative to SSB-a) may be indicated by a scrambling code/sequence in the first PBCH of SSB-a, where the scrambling code/sequence may be associated with the time offset value.

A frequency location of SSB-b, e.g., may indicate the absolute frequency location (e.g. carrier) or a relative frequency location of an SSB-b (e.g. next/nearest SSB-b signal of always-on or on-demand SSB-b) in terms of a frequency offset relative to the frequency location of SSB-a (e.g. center frequency) or a reference time point (e.g. point A). Such frequency offset may be indicated in units of subcarriers, carriers, resource elements, resource blocks.

Tx power parameters, e.g., may indicate at least one of predefined/preconfigured Tx power values used for SSB-a and/or SSB-b signals (always-on or on-demand). Such Tx power may be used by UE for pathloss estimation and/or for determining the Tx power for any UL transmissions (e.g. PRACH, UL-WUS). In an example, the Tx power for SSB-b may be indicated as an offset or scaling value that may be applied to the Tx power of SSB-a or a reference power value (e.g. max Tx power). In this case, the WTRU may determine the Tx power of SSB-b based on the Tx power of SSB-b and the corresponding power offset value, for example. Other parameters that may be indicated in first PBCH may include p0 and alpha value, which may be associated with power control.

An indication of on-demand SSB-b triggering (e.g. indicating ids/indexes) may be associated with any of the one of more on-demand SSB-b configs. For example, different OD-SSB-b configs may be associated with different sets of parameters. The indication may indicate at least one of the preconfigured OD-SSB-b configs that may be active/non-active, for example. For example, one or more bits in a bitfield may indicate whether an OD-SSB-b config is triggered or expected to be triggered in a period. Such indication may be applicable for NW-triggered OD-SSB-b, where the NW may initialize the OD-SSB-b transmission. In an example, the parameters associated with an OD-SSB-b config may be indicated (e.g. index, duration, number of bursts, start time) may be indicated in associated bitfields. In an example, the triggering of OD-SSB-b transmission may be indicated in PDCCH, which may be monitored by the WTRU in a preconfigured/indicated set of resources (e.g. CORESET/SS). In an example, an indication on (de)activation of OD-SSB-b configs may be received in a bitmap format, possibly with a certain configured length corresponding to the number of configured OD-SSB-b configs, where the bit ‘1’ in the bitmap may indicate the activation of an OD-SSB-b config and bit ‘0’ may indicate deactivation of an OD-SSB-b config. When receiving an activation indication, the WTRU may assume the signals/beams associated with the OD-SSB-b configs are usable. The WTRU may assume the info/resources in the activated OD-SSB-b configs may be used immediately, after certain application time (e.g. configured/indicated) or after receiving another triggering indication, for example. When receiving a deactivation indication, the WTRU may assume the info/resources in the deactivated OD-SSB-b configs may be unused immediately, or after certain application time (e.g. configured/indicated), for example. In examples, the indication may include info on new or updated parameters associated with the OD-SSB-b configs. For example, the indication may indicate a set of new parameters (e.g. in time, frequency, spatial domain) for one or more SSB-b configs.

Signalling indicating the activation/deactivation of NES adaptations/states may indicate the NES adaptation schemes (e.g. ids/indexes) such as SD/PD adaptations and cell DTX/DRX, based on which the WTRU may determine/identify the associated SSB-b configs. for example. In an example, the indication may include the timing info (e.g. in terms of absolute time symbols/slots/ms or relative time with respect to reference symbols/slots/ms) indicating when the NES adaptation is expected to start/end.

In some embodiments, the WTRU may be preconfigured with one or more sets of parameters/indications that may be included in different first PBCH formats. For example, a first set of parameters (e.g. {SFN, scaling value of periodicity}) may be included in one first PBCH format and second set of parameters (e.g. {time location of SSB-b, frequency location of SSB-b}) may be included in another first PBCH format. Since different set of parameters may be included in different first PBCH formats each may contain different number of bitfields and different bitfield lengths. The different first PBCH formats may be associated with different index values. In an example, the first PBCH in SSB-a may include the index value associated with the first PBCH format based on which the WTRU may determine the bitfields (e.g. number of bitfields, length of each bitfield) and the associated parameters.

For minimizing the payload size of the first PBCH, a subset (e.g., only a subset) of the parameters in the first PBCH may be provided explicitly. The remaining subset of parameters may be derived by the WTRU implicitly based on a combination of limited number of bits in the first PBCH and other parameters that may be predefined/preconfigured (e.g. in the association info). In another example, a subset of the parameters may be implicitly indicated based on scrambling codes that may be used to scramble one or more bitfields associated with the parameters indicated in the first PBCH. For example, the scaling factor or the SFN where SSB-a may be located may be indicated based on a scrambling code, where there may be K different codes in a codebook (for indicating K possible SFN values) with each code may be of a fixed length. In this case, the SFN of SSB-a may be indicated by using an associated scrambling code and scrambling one or more parameters in the first PBCH of the SSB-a, for example. Upon receiving the first PBCH, the WTRU may determine the SFN of SSB-a by unscrambling the associated parameters in first PBCH using a suitable scrambling code.

In an example, the WTRU may not receive the scaling factor for periodicity and/or duration of OD-SSB-b that may be transmitted by the cell. The WTRU may determine the periodicity and/or duration of OD-SSB-b relative to the periodicity of SSB-a based on the predefined scaling factor (e.g. periodicity of SSB-b is 4× periodicity of SSB-a). The WTRU may determine the periodicity or duration of OD-SSB-b or the index of a corresponding OD-SSB-b config based on the SSB-a periodicity (e.g. by monitoring SSB-a signals in at least 2 occasions/periods) and the association info between the SSB-a periodicity and the OD-SSB-b periodicity/duration or the OD-SSB-b config index.

In an example, the WTRU may determine the candidate time locations of OD-SSB-b signals that may be transmitted (e.g. in terms of SFNs) within a window based on a detection of a bit in the first PBCH of SSB-a in one or more SFNs where SSB-a signals are received and the predefined association info, indicating the presence of the bit in first PBCH and the presence of OD-SSB-b signals within the window. For example, when the first PBCH of SSB-a received in one or more SFNs contains a bit with a value ‘1’ (e.g. in a bitfield), the WTRU may assume that at least one OD-SSB-b signal may be transmitted in one or more of the SFNs corresponding to a window.

A similar approach may be applied for determining the time offset and/or frequency offset of OD-SSB-b based on some bits in the first PBCH and the association info between properties of SSB-a and OD-SSB-b. For example, the WTRU may use one or more bits indicated in the first PBCH (in a bitfield) and derive the time/frequency offset based on the bit value and the association between periodicity of SSB-a and the bit value.

In an embodiment, the WTRU may determine the time and/or frequency locations of SSB-a based on predefined/preconfigured information and/or the information in or associated with the first PBCH of the SSB-a signals. For example, the WTRU may determine the SFN of one or more SSB-a signals based on an indication corresponding to the SFN (e.g. x bits) in the first PBCH. In some examples, a same value may be indicated and/or repeated in a bitfield of the first PBCH corresponding to the SFN of SSB-a for a certain number of repetitions or a cycle duration. In this case, the WTRU may determine the SFN of the SSB-a based on monitoring of the SSB-a signals for a certain period (e.g. 1 repetition cycle), possibly until a change or increment in the value is detected.

In another example, the WTRU may determine the SFN of SSB-a based on a scrambling code that may be used for scrambling any of the first sync signal, DMRS of first PBCH and the first PBCH payload. For example, for a set of K scrambling codes (e.g. K may be associated with the periodicity of SSB-a and/or the scaling factor of the periodicity of SSB-b), the WTRU may determine the SFN of SSB-a based on the index of the scrambling code and the association between the K SFNs and K indexes of the scrambling codes.

The WTRU may perform measurements on the received SSB-a signals/beams, possibly received in the determined time/frequency locations. Such measurements, possibly on the one or more of SSB-a signals/beams in a burst, may be associated with any of L3, L2 and/or L1 measurements. The WTRU may identify a best SSB-a signals/beam from the set of active SSB-a signals/beams in a burst based on highest RSRP measurements, for example.

In certain embodiments, the WTRU may transmit an UL-WUS indication and/or signal. For example, the WTRU may transmit an WUS indication possibly when meeting triggering conditions and/or criteria, which may be based on the measurements made on SSB-a and info the first PBCH of SSB-a. Such UL-WUS may be transmitted, for example, to request on-demand SSB-b transmissions from the cell. In an example, the UE may transmit the UL-WUS indication using UL-WUS resource config, possibly indicated in the first PBCH of SSB-a, where the resource may possibly be associated with the SSB-a signal selected based on measurements (e.g. best SSB-a). Such UL-WUS may be transmitted using the spatial filter associated with the selected SSB-a signal/beam, or a reference signal/beam, for example.

In an example, when transmitting an UL-WUS indication, the WTRU may indicate to NW a property associated with any of the device-type, coverage condition, QoS info, etc, possibly based the association information configured/received by the WTRU indicating the association between the property and the resources used for the UL-WUS indication. In this case, the transmisison of an UL-WUS indication using such associated resource may indicate a request to the NW for a particular on-demand SSB configuration (e.g. long/short periodicity, long/short transmisison duration, high/low Tx power) possibly known to the WTRU based on the association information, where the on-demand SSB configuration that may be suitable for the WTRU or a property associated with the WTRU (e.g. device type, device capability, coverage condition). For example, a WTRU of a LPWA device type may select a UL-WUS resource (e.g. WUS preamble, sequence or WUS occasion in time/frequency domain) from a pool of resource that may be associated with the LPWA device type. In this case, such pool of resources may be used only by the devices associated with such device type (e.g. LPWA device). In an example, the WTRU may be configured/indicated with association information that may indicate the association between between M SSB-a beams and N UL-WUS resources (e.g. WUS occasions in time/frequency domain), where the N UL-WUS resources may be associated with the K properties. The WTRU may select a UL-WUS resource, possibly from a pool of UL-WUS resources (e.g. N UL-WUS resources associated with a selected SSB-a beam), based on the associated property when transmitting the UL-WUS. The transmisison of UL-WUS using such associated resource may indicate to network the associated property.

Such UL-WUS indication may be used for indicating other requests, preference or assistance information to the cell on any of the following: request to increase periodicity of OD-SSB-b transmissions, including periodicity of associated signals (e.g. second/third sync signals, second PBCH, MIB, SI), request to increase/decrease start time of OD-SSB-b transmission, request to increase/decrease duration of OD-SSB-b transmission (e.g. in terms of number of bursts, absolute time or relative/scaled time with respect to a reference time duration), request to transition to a new or non-NES state, request for UL grant for SR/BSR/data transmission, request to activate/deactivate transmission of certain SSB-a/SSB-b beams (e.g. beam indexes), indication of preference for certain SSB-a/SSB-b beams (e.g. beam indexes), request for CSI-RS transmission via certain beams, and/or request for any MIB/SI/SIB.

Such preference or assistance info may be indicated by the UE using associated UL-WUS resources (e.g. preambles, sequences, RACH/WUS occasions), which may be selected from one or more of the pre-configured/indicated UL-WUS configs.

In an example, the WTRU may transmit the UL-WUS during a WUS occasion (WO) in any of time and frequency domains, during which the cell may monitor for any UL-WUS transmission from the WTRU, for example. Such WOs may be associated with the UL-WUS config (provided in first PBCH) and/or the properties of SSB-a (e.g. periodicity, time/frequency location, beams). In the case when a WUS occasion pattern is configured/indicated (e.g. comprising of time/frequency locations, periodicity of WOs, WO duration, start slot/offset), the WTRU may transmit the UL-WUS indication during the next available WUS occasion, possibly associated with the selected SSB-a. If a WUS occasion pattern is not configured/indicated, the WTRU may assume the availability of a WUS occasion N SFNs/subframes/symbols (e.g. N=1) after the reception of the SSB-a in an SSB-a burst (e.g. last symbol of SSB-a in a burst), for example.

In an example, the WTRU may be configured with one or more UL-WUS resources (e.g. preambles, sequences, WUS/RACH occasions) that may be associated with any of different cells, SSB-a signals/beams/configs and OD-SSB-b configs/signals/beams. The WTRU may select an UL-WUS resource for transmission based on whether the indication is intended to be cell-specific, SSB-a signal specific or OD-SSB-b specific. For example, the WTRU may select a cell-specific UL-WUS resource when transmitting UL-WUS to a particular cell or when requesting OD-SSB-b transmission from a particular cell. In this case, the WTRU may scramble the UL-WUS resource with a cell-specific scrambling sequence when transmitting UL-WUS indication, for example. In another example, the WTRU may select an SSB-a signal/beam specific UL-WUS resource/sequence for indicating a particular SSB-a index/signal/beam that is used as a reference when transmitting UL-WUS. In another example, the WTRU may select an OD-SSB-b signal/beam/config specific UL-WUS resource/sequence when requesting a particular OD-SSB-b signal/beam/config.

The triggering conditions/conditions used by the WTRU for determining whether/when to transmit the UL-WUS indication may be related to any of RSRP measurements of SSB-a signals, time to the nearest always-on SSB-b signal (if transmitted), absence of an indication on OD-SSB-b triggering (e.g. in first PBCH), absence of a WUS response indication (for a monitoring duration) and/or termination of OD-SSB-b transmission. In this case, the WTRU may transmit UL-WUS within k time units (e.g. SFNs, subframes, symbols) upon detecting one or more of the triggering conditions. For example, in the case when always-on SSB-b may be transmitted by cell with long periodicity, the WTRU may transmit UL-WUS to request for OD-SSB-b transmission if the determined time gap between the last SSB-a signal and the next/nearest always on SSB-b signal is greater than a threshold corresponding to X time units (e.g. SFNs, subframes, symbols). The WTRU may use the nearest available WUS occasion from detecting the trigger, possibly within k time units, for transmitting an UL-WUS indication. Alternatively, the WTRU may trigger and transmit UL-WUS indication for requesting on-demand SSB-a transmissions, possibly when the existing SSB-a signals are insufficient (e.g. periodicity of always-on SSB-a is above a threshold, RSRP measurements of SSB-a is below a threshold).

In an example, the WTRU may trigger and/or transmit a UL-WUS indication for requesting to terminate/stop OD-SSB-b transmission, possibly when any of the conditions associated with triggering an initial/first UL-WUS are met (e.g. L1/L3 measurements made on OD-SSB-b are above a threshold, WTRU successfully received a target SI provided via OD-SSB-b). In this case, upon receiving one or more bursts of OD-SSB-b transmisisons, possibly after transmitting a first UL-WUS indication, the WTRU may send a second UL-WUS indication to request to stop the OD-SSB-b transmisison. When requesting to stop/terminate the OD-SSB-b transmisison, the WTRU may select a UL-WUS resource (e.g. preamble, sequence, WUS/RACH occasions) associated with indication of stopping/terminating UL-WUS transmisison. Alternatively, the WTRU may include the same information (e.g. scrambling sequence/code associated with UE ID) indicated in the first UL-WUS for transmitting the second UL-WUS, such that the NW may be made aware of the request for terminating OD-SSB-b transmisison. Alternatively, when transmitting the UL-WUS indication, the WTRU may use the resources or indicate information associated with terminating OD-SSB-b based on the resources/information received in the WUS response indication.

The other conditions which may be monitored by the WTRU for transmitting UL-WUS may include the validity timer associated with any of the UL-WUS config (indicated in first PBCH of SSB-a), SSB-a signal/beam and TA timer (TAT). For example, the WTRU may transmit an UL-WUS if or when the TAT is not expired. Similarly, the WTRU may transmit an UL-WUS if or when the beam validity timer is expired.

In an example, the WTRU may perform power control when transmitting UL-WUS indication, where the power control parameters may be determined based on the measurements of SSB-a (e.g. pathloss measurements) and possibly based on the info received in the first PBCH (e.g. on Tx power of SSB-b, alpha, p0) of SSB-a.

In an example, the UL-WUS indication may be transmitted with repetitions (e.g. N number of transmissions), where the number of repetitions may be determined based on the radio conditions (e.g. RSRP/pathloss measurements made on SSB-a). For example, the WTRU may transmit UL-WUS with no repetitions when the measured RSRP is greater than a threshold. The WTRU may transmit UL-WUS with n1 repetitions when the measured RSRP is within a first range and with n2 repetitions when the measured RSRP is within a second range. In another example, the WTRU may transmit UL-WUS periodically, possibly for a certain duration, possibly when the indicated UL-WUS config (in first PBCH) may be associated with periodic resources.

In an example, the WTRU may start a prohibit timer upon transmitting an UL-WUS indication. Upon starting the prohibit timer the WTRU may not be allowed to transmit any subsequent UL-WUS indications until the expiry of the prohibit timer or upon reception of a WUS response indication.

In some embodiments, the WTRU may receive a WUS response indication. For example, the WTRU may receive the WUS response indication, e.g., possibly upon transmitting an UL-WUS indication. Such WUS response indication may be received via an explicit indication (e.g. in a DCI), possibly in a WUS response monitoring configuration (e.g. common search space or CORESET) or via an implicit indication with the reception of OD-SSB-b signals, possibly with a certain predefined/preconfigured start duration after UL-WUS transmission.

For receiving an explicit WUS response indication, the WTRU may be configured/indicated (e.g. in first PBCH) with time/frequency monitoring resources, which the WTRU may monitor for a certain time window (e.g. configured with a start time and duration in terms of SFNs, subframes, symbols, ms), possibly with a certain periodicity. The WTRU may start the time window for receiving the WUS response, possibly within m time units upon transmitting the last UL-WUS indication. For example, the WTRU may start a timer associated with the WUS response window m symbols/slots (e.g. m=1) after transmitting the UL-WUS indication. The WTRU may monitor for a WUS response indication while the timer is running, for example. The WTRU may stop and reset the timer, upon receiving a WUS response, for example.

In certain embodiments, the WUS response indication may be received in any of the following: L1 signaling, L2 signaling, and/or L3/RRC signaling.

For L1 signaling, such indication may be received in a DCI, including in any of cell-common, group-common, UE-dedicated DCI formats. Such DCI may include any of a WUS response DCI (e.g. scrambled with a new RNTI), RACH response DCI (e.g. scrambled with RA-RNTI), SI DCI (e.g. scrambled with SI-RNTI), paging DCI (e.g. scrambled with paging DCI), paging early indication DCI (e.g. scrambled with PEI-DCI), wake-up or LP-WUS DCI and measurement related DCI (e.g. aperiodic CSI trigger). Such DCI may include any of scheduling or non-scheduling DCI formats, possibly when received in CONNECTED mode. In examples, such indication may be received in a new signal/channel that may be encoded with a sequence that may be detected/decoded by the UE. Such a signal may include any of LP-SS transmission, and first/second/third sync signal. In an example, a WUS response indication may be received the first PBCH of SSB-a transmissions. In this case, the UE may monitor one or more SSB-a transmissions for the response indication in the first PBCH, possibly upon UL-WUS transmission.

For L2 signaling, such indication may be received in MAC CE or any access stratum (AS) layer signaling such as PDCP or RLC control PDU, possibly when received in CONNECTED mode.

For L3/RRC signaling, such indication may be received in any dedicated RRC messages for UE in CONNECTED/INACTIVE mode in broadcast messages (e.g. first PBCH of SSB-a, second PBCH of SSB-b, MIB, SIBx) for UE in IDLE mode.

In some embodiments, the received WUS response indication may include one or more of the following info/parameters. Some of the info/parameters may be the same or updates to the information included in the first PBCH of SSB-a (e.g. WTRU may use latest parameters indicated in the WUS response). The remaining info/parameters in the WUS response may be new which are not includes in the first PBCH of SSB-a.

The info/parameters in the WUS response may include any one or more of the following: status of OD-SSB-a transmission, index of OD-SSB-b config, parameters of OD-SSB-b, SFN, indication of UL-WUS resource/config, scaling factor for periodicity of OD-SSB-b, scaling factor value for the duration of on-demand SSB-b, indication of priority, indication of additional resources, Tx power parameters, and/or indication on the activation/deactivation of NES adaptations/states.

A status of OD-SSB-a transmission, for example, may indicate whether OD-SSB-b is transmitted or not transmitted. For example, when bit ‘0’ in an associated bitfield of the WS response is received, the UE may assume OD-SSB-b is not transmitted by the cell. Similarly, when bit ‘1’ in an associated bitfield of the WS response is received, the UE may assume OD-SSB-b is transmitted by the cell.

An index of OD-SSB-b config, for example, may indicate the OD-SSB-b config that may be expected to be transmitted by cell.

Parameters of OD-SSB-b, for example, may include any of the periodicity, duration, time location in terms of start time offset (e.g. with respect to a reference time point including UL-WUS transmission time, start/end of monitoring window, last SSB-a transmission) and frequency location in terms of frequency offset (e.g. with respect to a reference frequency point, including center frequency of SSB-a, center frequency of carrier).

SFN, for example, may indicate the SFN value where OD-SSB-b is located (e.g. nearest/next OD-SSB-b).

An indication of UL-WUS resource/config, for example, may indicate index/ID associated with the UL-WUS resource/config that may be selected/used by the UE (e.g. preamble index, sequence index/ID).

A scaling factor for periodicity of OD-SSB-b, for example, may indicate the periodicity of OD-SSB-b is 2× the periodicity of SSB-a.

A scaling factor value for the duration of on-demand SSB-b, for example, may indicate the duration of OD-SSB-b (e.g. in terms of N number of bursts, ms) is K multiple of the periodicity of SSB-a (e.g. where K<1 and K>=1).

An indication of priority may indicate the priority value associated with the activated on-demand SSB-b config. In an example, when any of the SSB-b signals associated with different always-on SSB-b and on-demand SSB-b configs overlap in any of time, frequency or spatial domains, the UE may use the indicated priority value for determining which of the SSB-b signals to be selected and/or used, e.g. for measurements, cell (re)selection, initial access, etc. In this case, the UE may select the SSB-b signals associated with the SSB-b config with the highest priority, for example.

An indication of additional resources may indicate an index to a predefined/preconfigured set of additional resource configs in time/frequency domain, includes those related to configured grant resources or small data transmission resources. In an example, an additional resource config may be implicitly indicated based on presence of a bit (e.g. value ‘1’) in a bitfield which may indicate allocation of additional resources and the association between the additional resource config and a property of OD-SSB-b (e.g. periodicity or duration of OD-SSB-b). For example, 2 bits in a bitfield may indicate one of 4 additional resource configs which may be associated with the periodicity/duration of OD-SSB-b. The indication may indicate the validity of additional resource config, including time validity (e.g. timer value) and spatial validity (e.g. list of cells/PCIs). The indication may indicate whether the additional resource config may be associated with any of periodic, semi-persistent (e.g. periodic over a time duration/window) or aperiodic resources.

Tx power parameters, for example, may indicate at least one of predefined/preconfigured Tx power values used for OD-SSB-b signals. Such Tx power may be used by UE for pathloss estimation and/or for determining the Tx power for any UL transmissions (e.g. PRACH associated with SSB-b beam). In an example, the Tx power for SSB-b may be indicated as an offset or scaling value that may be applied to the Tx power of SSB-a or a reference power value (e.g. max Tx power). In this case, the UE may determine the Tx power of SSB-b based on the Tx power of SSB-b and the corresponding power offset value, for example. Other parameters that may be indicated in WUS response may include index to p0 and/or alpha values, which may be associated with power control.

An indication on the activation/deactivation of NES adaptations/states, for example, may indicate the NES adaptation schemes (e.g. ids/indexes) such as SD/PD adaptations and cell DTX/DRX, based on which the UE may determine/identify the associated OD-SSB-b configs. for example. In an example, the indication may include the timing info (e.g. in terms of absolute time symbols/slots/ms or relative time with respect to reference symbols/slots/ms) indicating when the NES adaptation is expected to start/end.

In some embodiments, when the WUS response may indicate additional resources are available for UL transmission, the WTRU may transmit an indication including any of a request to increase SSB-b repetitions, change periodicity of OD-SSB-b, measurement report related to the measurements made on SSB-a, ID/index of UL-WUS resource, and request for one or more SI. Such indications/information may be transmitted by a WTRU using (e.g., with) any of PRACH preamble, MSG-A, and/or small data transmission, possibly using the indicated resources.

In an example, the WUS response may indicate the properties of the OD-SSB-b transmission, where such properties may be based on the UL-WUS transmisison (e.g. resource used for UL-WUS or information encoded in the UL-WUS when requesting OD-SSB-b). The properties associated with OD-SSB-b may include any of: id/index of OD-SSB-b config, periodicity of OD-SSB-b, transmission duration per OD-SSB-b signal/beam (e.g. number of symbols), frequency resources/location (e.g. number of RE/RBs in a bandwidth part, location within or outside of bandwidth part, carrier), number of repetitions, number of bursts, transmisison duration, comb pattern and Tx power. Such properties of OD-SSB-b may or may not be associated with the request/information included in the UL-WUS transmisison. For example, when a WTRU of a particular device type (e.g. LPWA device) transmits a UL-WUS indication, possibly containing information about the device type, the WUS response indication may include an ID/index associated with an OD-SSB-b configuration that may be suitable for the particular device type. In this case, the OD-SSB-b may be received by the WTRU with a higher number of repetitions, longer transmission duration in time domain, narrow band resources in frequency domain, higher Tx power, etc, for example. Similarly, when a WTRU experiencing a particular radio coverage condition (e.g. RSRP measurements on SSB-a above or below a threshold) transmits an UL-WUS indication, possibly containing information on the coverage condition or measurements, the WUS response indication may include an ID/index or parameters associated with an OD-SSB-b configuration that may be suitable for the particular coverage conditions.

In an example, the WUS response may be received via the same/similar beam (e.g. similar beam properties at WTRU) used by the WTRU for transmitting the UL-WUS indication. In this regard, the WTRU may monitor for the WUS response using one or more Rx spatial filters (e.g. ports, weights) and beams that may be associated with the spatial filters used for UL-WUS transmission (e.g. same beam and beams that are spatially nearby).

In an example, if a WUS response is not received by the WTRU before the end of the monitoring window or before the expiry of a WUS response timer, the WTRU may monitor for an implicit WUS response in the form of initiation of new SSBs, including any of new SSB-a, new always-on SSB-b or new OD-SSB-b transmissions. For example, the first PBCH in SSB-a received after the monitoring window may include a WUS response indication (e.g. in an associated bitfield of first PBCH). The monitoring for new SSBs may be done by the WTRU, for certain time duration, before and/or after the end of the monitoring window or the expiry of the WUS response timer. The WTRU may select a new SSB based on measurements (e.g. L1 RSRP) and using criteria associated with the measurements (e.g. RSRP measurements of the new SSB is above a threshold value and/or highest among the detected new SSBs). The WTRU may transmit a RACH preamble associated with the selected new SSB beam and may receive the RACH response (RAR).

In another example, if an explicit WUS response is not received by the WTRU before the end of the monitoring window or before the expiry of the WUS response timer, the WTRU may retransmit the UL-WUS indication, possibly after the expiry of any associated prohibit timer. The WTRU may retransmit the UL-WUS indication for N configured instances/attempts, before termination and/or releasing any UL-WUS configuration. For example, the WTRU may use any of the associated info (e.g. UL-WUS config, indication on OD-SSB-b transmission, Tx power parameters) in the latest first PBCH of SSB-a when retransmitting UL-WUS. The WTRU may also reselect the UL-WUS resources associated with a new selected SSB-a when retransmitting the UL-WUS indication.

According to certain embodiments, the WTRU may determine the candidate time and/or frequency (T/F) locations of the OD-SSB-b signals. For example, the WTRU may determine the candidate time and/or frequency locations of the OD-SSB-b signals based on the information in the first PBCH of SSB-a and/or the WUS response indication. For determining the candidate T/F locations (e.g. the SFNs and the carriers where OD-SSB-b signals may be transmitted) the WTRU may initially determine the periodicity of SSB-a. The WTRU may determine the periodicity of the SSB-a based on the indication on SSB-a config provided in the first PBCH of SSB-a and/or based on monitoring of the SSB-a signals in at least 2 occasions. The WTRU may then determine the periodicity of the OD-SSB-b (e.g. containing the MIB/SI) based on periodicity of the SSB-a and the scaling factor (e.g. 2×) indicated in the first PBCH and/or WUS response indication. For example, if the periodicity of the SSB-a is determined to be 20 ms and the scaling factor indicated by the first PBCH or WUS response is 8, then the WTRU may determine the periodicity of the SSB-b to be 160 ms.

In an example, the WTRU may determine which period (e.g. same or subsequent period) relative to the SSB-a transmission includes a transmission of the OD-SSB-b based on the reception of an SSB-a in a first period. Similarly, the WTRU may determine which period (e.g. same or subsequent period) relative to the UL-WUS transmission includes a transmission of the OD-SSB-b based on the transmission of UL-WUS in a first period. In this case, the period may correspond to any of the SFN, time window, and cycle, for example. The first PBCH of the SSB-a or the WUS response may include a value indicating in which period (e.g. SFN) relative to the period of the SSB-a transmission or the UL-WUS transmission includes a transmission of the OD-SSB-b. For example, a value of 3 may indicate the OD-SSB-b transmission occurs 3 SSB-a time periods (e.g. 3 SFNs) after the period in which the SSB-a is received or in which UL-WUS is transmitted. The WTRU may determine the period in which OD-SSB-b is expected to be received based on a scrambling code/sequence. For example, the first PBCH of the SSB-a or the WUS response indication may be scrambled with a scrambling code/sequence that may indicate a value associated with when the OD-SSB-b is transmitted or received relative to the SSB-a or UL-WUS transmission.

In an example, the WTRU may determine candidate time locations of OD-SSB-b signals based on parameters of OD-SSB-b config (duration, periodicity) and the reception time of WUS response indication. For example, the WTRU may determine candidate time locations of OD-SSB-b signals, relative to the SFN in which the WUS response indication is received (e.g. in SFNx), as {SFN #x+1+i, where i=1, 2, 3, 4} based on the start offset value (e.g. 1 SFN) and OD-SSB-b duration (e.g. 4 SFNs) indicated in WUS response indication.

In an example, the WTRU may determine candidate time locations of OD-SSB-b signals relative to the time location of an SSB-a signal based on the time location of at least one SSB-a signal (e.g. in SFN #x) associated with an OD-SSB-b config, the time offset of OD-SSB-b (indicated in first PBCH or WUS response), reference SFN of OD-SSB-b, duration of OD-SSB-b (e.g. N number of bursts in a window or number of cycles) and the periodicity of OD-SSB-b (e.g. derived from periodicity of SSB-a and associated scaling factor). The WTRU may use a modulo function to initially determine the candidate locations of OD-SSB-b signals (e.g. in terms of SFN indexes) starting from the reference SFN (e.g. SFN #0) and as a function of the OD-SSB-b periodicity and duration. The time locations of OD-SSB-b signals relative to an SSB-a signal (e.g. next/nearest OD-SSB-b signal from the SSB-a signal) may then be determined based on the SFN of the SSB-a and the initially determined candidate locations of OD-SSB-b. For example, for an OD-SSB-b periodicity of 8 SFNs (160 ms) and duration of 2 cycles/periods, the initially determined candidate locations of SSB-b may correspond to any of {SFN #6, SFN #14}, {SFN #14, SFN #22}, {SFN #22, SFN #30}. Then based on determination of SFN of SSB-a (e.g. SFN #7), the WTRU may determine the time locations of the nearest OD-SSB-b to be at {SFN #14, SFN #22}.

In an example, the WTRU may determine candidate frequency locations of OD-SSB-b signals based on the frequency location of SSB-a signal (e.g. center frequency of resource blocks of SSB-a) and frequency offset of SSB-b that may be indicated in the first PBCH of SSB-a or WUS response indication. In this case, the WTRU may first determine the frequency location of SSB-a (e.g. on a carrier) based on the predefined/preconfigured info and calculate the frequency location of OD-SSB-b based on the offset value indicated in the WUS response indication.

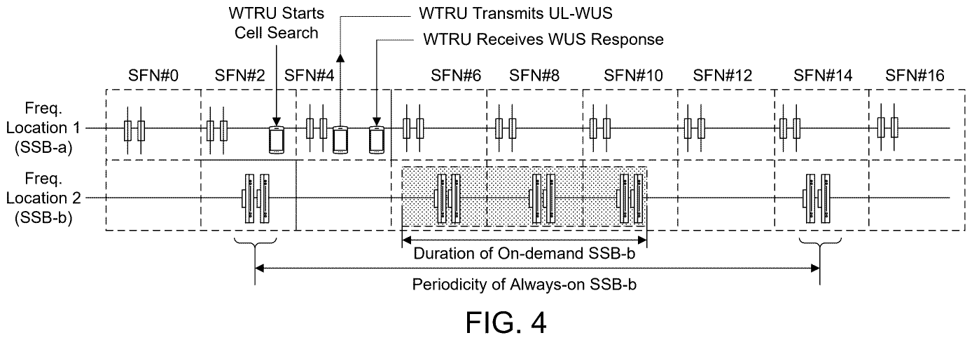

FIG. 4 illustrates an example showing the procedure for UL-WUS transmission, reception of an WUS response indication and on demand SSB-b transmission, according to some embodiments. FIG. 4 also illustrates the difference in the transmission pattern between always-on SSB-b and on demand SSB-b transmission.

In some embodiments, the WTRU may receive one or more OD-SSB-b signals or one or more signals of OD-SSB-b (e.g. signals containing second/third sync signals, second PBCH, MIB/SI). Such OD-SSB-b signals may be associated with at least one active OD-SSB-b configuration. Such OD-SSB-b signals, possibly in combination with other always-on SSB-b signals, may be received by a WTRU when supporting any functions associated with IDLE mode (e.g. cell (re)selection, synchronization, SI update, paging) and/or CONNECTED mode (e.g. L1/L3 measurements, RLM, BM).

In some embodiments, the OD-SSB-b signals received by the WTRU may be received with properties that may be associated with the UL-WUS transmisison (e.g. resource used for UL-WUS or information encoded in the UL-WUS when requesting OD-SSB-b). The properties associated with OD-SSB-b may include any of: id/index, periodicity of OD-SSB-b, transmission duration per OD-SSB-b signal/beam (e.g. number of symbols), frequency resources/location (e.g. number of RE/RBs in a bandwidth part, location within or outside of bandwidth part, carrier), number of repetitions, number of bursts, transmisison duration, comb pattern and Tx power. For example, when a WTRU of a particular device type (e.g. LPWA device) transmits a UL-WUS indication, possibly containing information about the device type, the OD-SSB-b received by the WTRU may be associated with an OD-SSB-b configuration that may be suitable for the particular device type. In this case, the OD-SSB-b received by the WTRU may be received with a higher number of repetitions, longer transmission duration in time domain, narrow band resources in frequency domain, higher/lower Tx power, etc, for example. Similarly, when a WTRU experiencing a particular radio coverage condition (e.g. RSRP measurements on SSB-a above or below a threshold) transmits an UL-WUS indication, possibly containing information on the coverage condition or measurements, the OD-SSB-b received by the WTRU may be associated with an OD-SSB-b configuration that may be suitable for the particular coverage conditions.

In an example, upon determining the time and/or frequency locations of OD-SSB-b signals, possibly based on the information provided via SSB-a signals and WUS response indication, the WTRU may start monitoring at least the nearest determined candidate time/frequency locations from the last received SSB-a signal, UL-WUS transmission or the last WUS response indication (e.g. next candidate SFN from the SFN of last WUS response) for receiving the OD-SSB-b signals. The received OD-SSB-s signals may be used for any of measurements, cell (re)selection, paging, initial access, etc. The WTRU may receive the OD-SSB-b signals containing MIB and/or the common SS config for receiving PDCCH associated with a target SI (e.g. cell selection info, RACH config). Such PDCCH (e.g. DCI encoded with a SI-RNTI) may indicate the PDSCH in which the target SI may be received.

In an example, the WTRU may receive the OD-SSB-b signals and perform any of measurements, cell selection, etc., while continuing to monitor the WUS response monitoring configuration. The WTRU may receive a stopping indication (e.g., a termination indication) in the monitoring configuration indicating the stopping or termination of OD-SSB-b transmission. Such indication may be received in any of the WUS response indication (e.g. another response indication for stopping) and/or a DCI (e.g. cell-common or group common DCI). The WTRU may assume the OD-SSB-b transmission is stopped after a preconfigured m time units (e.g. time units may correspond to m SFNs, subframes, symbols, ms) or after certain indicated time units (e.g. in the stopping indication) upon receiving the stopping indication. The WTRU may stop monitoring for OD-SSB-b transmission, possibly after expiry of an associated timer, for example, upon receiving the stopping indication.

In an example, the WTRU may determine the periodicity of the SS for receiving PDCCH for a target SI (e.g. SIBx, possibly for cell selection, initial access) based on the periodicity of the SSB-a and the associated scaling factor indicated in the first PBCH or in the second PBCH of the OD-SSB-b. The WTRU may receive the PDCCH associated with the target SI in the SS according to the determined periodicity of the SS. Upon receiving the target SI (e.g. in PDSCH) the WTRU may select the cell and/or transmit an indication to the cell using the resources indicated in the target SI. Such indication transmitted by the WTRU may include a PRACH preamble which may be transmitted in the resources (e.g. WUS/RACH occasions in time and/or frequency domain) which may be associated with one or more properties of SSB-a and/or OD-SSB-b signals (e.g. periodicity, time/frequency location), for example.

Some embodiments may include the WTRU determining the cell to transmit a request for on-demand SSB-b (OD-SSB-b) transmission. For example, in certain embodiments, related to multi-cell deployment, the WTRU may determine the cell to transmit an UL-WUS indication to request for on-demand SSB-b transmissions based on predefined/preconfigured association info and info in SSB-a transmissions received from one or more cells. Such cell may be any of an anchor cell (e.g. coverage cell) or an NES cell (e.g. capacity cell or cell operating in an NES mode). The WTRU may determine the cell to transmit UL-WUS indication during cell (re)selection, possibly when in IDLE mode, for example. The cell selected by the WTRU for transmitting UL-WUS indication may not be transmitting always-on SSB-b signals or may be transmitting SSB-b with a long periodicity.

In some embodiments, the WTRU may determine the locations of any of SSB-a, always-on SSB-b and on-demand SSB-b signals in time/frequency domains based on predefined/preconfigured information and information in contained the SSBs. The WTRU may initially receive one or more SSB-a signals from one or more cells. The WTRU may be predefined or preconfigured with the SSBs transmitted by the cells including any of SSB-a configurations (e.g. first sync signal and a first PBCH), always-on and/or on-demand SSB-b configurations (e.g. second and possibly a third sync signal, second PBCH, MIB) and association information between SSB-a and SSB-b. The WTRU may determine the resources for requesting on-demand SSB-b transmissions based on the information in SSB-a signals, possibly those received from an anchor cell. The WTRU may determine the locations for receiving the on-demand SSB-b from the selected cell based on the first PBCH received in SSB-a and the predefined association info between the SSB-a and SSB-b.

In some embodiments, a WTRU may be predefined or configured with parameters associated with SSBs. For example, according to certain embodiments, a WTRU may be predefined and/or receive configuration info (e.g., parameters), from a NW, associated with the SSB-a and SSB-b transmitted by one or more cells. Such predefinition or configuration info may be the same or similar as that described in the previous section of this disclosure. Additionally, the WTRU may be predefined/preconfigured with association information between SSB-a and SSB-b signals.

For example, the association information between SSB-a and SSB-b signals may include any of the following: association between the type of SSBs and cells, association between a set of SSB-a configs (always-on and on-demand) and cells, and/or association between a set of SSB-b configs (always-on and on-demand) and cells.

The association between the type of SSBs and cells may include, for example, the always-on SSB-a may be transmitted by cells with PCIs {cell #0, cell #1, cell #3, cell #4}. The cell #0 may be an anchor cell and the remaining cells may be NES cells. Cell #2 may be configured as a cell without SSB-a transmissions. For example, the on-demand SSB-a may be transmitted by cells with PCIs {cell #1, cell #2}. In this example, cell #1 and cell #2 may support transmission of OD-SSB-a, which may be triggered by the network or by the UE transmission of an UL-WUS indication. For example, the always-on SSB-b may be transmitted by cells with PCIs {cell #0, cell #1}. For example, the on-demand SSB-b may be transmitted by cells with PCIs {cell #0, cell #1, cell #2, cell #3}. In this example, the cell #0 to cell #3 may support transmission of OD-SSB-b, which may be triggered by the network or by the UE transmission of an UL-WUS indication.

The association between a set of SSB-a configs (always-on and on-demand) and cells may include, for example, the SSB-a configs of {SSB-a #1, SSB-a #3} may be associated with the cells with PCIs {cell #0, cell #3} and the SSB-a configs of {SSB-a #2, SSB-a #4} may be associated with the cells with PCIs {cell #1, cell #4}. The WTRU may determine the properties of SSB-a signals (e.g. periodicity, time/frequency locations) transmitted by the cell based on the associated configuration information.

The association between a set of SSB-b configs (always-on and on-demand) and cells may include, for example, the SSB-b configs of {SSB-b #0, SSB-b #2} may be associated with the cells with PCIs {cell #0, cell #1, cell #2} and the SSB-a configs of {SSB-b #, SSB-b #3} may be associated with the cells with PCIs {cell #3, cell #4}. The WTRU may determine the properties of SSB-b signals (e.g. periodicity, time/frequency locations) transmitted by the cell based on the associated configuration information.

In some embodiments, the WTRU may receive SSB-a signals from one or more cells, such as any of anchor cells and/or NES cells. Such SSB-a signals may be received by the WTRU during any of the following: power on, when supporting any functions associated with IDLE mode (e.g. cell (re)selection, synchronization, SI update, paging), and/or when supporting functions associated with CONNECTED mode (e.g. L1/L3 measurements, RLM, BM). The SSB-a signals received by the WTRU may contain a first sync signal and/or a first PBCH (light PBCH). The first PBCH may include PBCH DMRS and/or payload (e.g. N1 bits). The WTRU may achieve synchronization with a cell transmitting SSB-a signals, e.g., based on detection/reception of the first sync signals in one or more SSB-a signals.

In addition to the information discussed above, the first PBCH in an SSB-a signal received from any of the cells (e.g. in payload of first PBCH received from an anchor cell) may indicate any of the following: association between SSB-a configs and cells (e.g. indicates an index/id of the association between an SSB-a config and a list of cells, e.g., index indicating SSB-a #K is associated with cells with PCIs {cell #0, cell #2, cell #4}), association between SSB-b configs (always-on and/or on-demand) and cells (e.g. indicates an index/id of the association between an SSB-b config and a list of cells, e.g., index indicating SSB-b#M is associated with cells with PCIs {cell #0, cell #1, cell #2}), association between UL-WUS configs and cells (e.g. indicates an index/id of the association between an UL-WUS config and a list of cells, e.g., index indicating UL-WUS resources/config #X1 is associated with cells with PCIs {cell #0, cell #1, cell #3} and UL-WUS resources/config #X2 is associated with cells with PCIs {cell #0, cell #3, cell #4}), association between Tx power (SSB-a) and cells (e.g. indicates an index/id of the association between the Tx power used for transmitting SSB-a signals and a list of cells, e.g., index indicating Tx power level K is associated with cells with PCIs {cell #0, cell #2, cell #4} ), and/or association between UL-WUS triggering criteria (e.g. thresholds) and cells. For example, an association between UL-WUS triggering criteria (e.g. thresholds) and cells may indicate: association between the threshold values (e.g. RSRP thresholds of SSB-a for UL-WUS transmission and/or cell (re)selection) and list of cells (e.g. index indicating the RSRP threshold level is associated with cell with PCIs {cell #2, cell #4}), association between the bias offset to the RSRP/RSRQ threshold values and list of cells (e.g. index indicating the bias offset to the RSRP threshold level is associated with cell with PCIs {cell #0, cell #2}), and/or association between the bias offset to the time gap value (to the next/nearest SSB-b signal) and list of cells (e.g. index indicating the bias offset to the time gap is associated with cell with PCIs {cell #1, cell #3}). Such bias offset value may be intended to increase/decrease the possibility for UL-WUS transmission and/or cell (re)selection based on any of RSRP measurements and time gap to the next SSB-a. For example, a high bias offset value may be indicated to reduce the possibility for triggering UL-WUS to the cell, possibly to allow the cell to operate in NES mode for longer duration.

For example, to minimize the payload size of the first PBCH, a subset (e.g., only a subset) of the parameters in the first PBCH may be provided explicitly. The remaining subset of parameters may be derived by a WTRU implicitly based on a combination of limited number of bits in the first PBCH and other parameters that may be predefined/preconfigured (e.g. in the association info). In another example, a subset of the parameters may be implicitly indicated based on scrambling codes that may be used to scramble one or more bitfields associated with the parameters indicated in the first PBCH.

In an example, such association information may be received individually from each cell in the first PBCH of the corresponding SSB-a or jointly in the first PBCH of the SSB-a received from the anchor cell. For example, the SSB-s received from an anchor cell may provide the info (in first PBCH) associated with one or more NES cells that may be under the control of the anchor cell

According to some embodiments, a WTRU may determine the time and/or frequency locations of SSB-a. In an example, the WTRU may determine the time locations of SSB-a received from one or more cells, e.g., based on predefined/preconfigured information and/or the information in or associated with the first PBCH of the SSB-a signals. For example, the WTRU may determine the SFN of one or more SSB-a signals based on an indication corresponding to the SFN (e.g. x bits) in the first PBCH. In some examples, a same value may be indicated and/or repeated in a bitfield of the first PBCH corresponding to the SFN of SSB-a for a certain number of repetitions or a cycle duration. In this case, the WTRU may determine the SFN of the SSB-a based on monitoring of the SSB-a signals for a certain period (e.g. 1 repetition cycle), possibly until a change or increment in the value is detected.

In another example, the WTRU may determine the SFN of SSB-a based on a scrambling code that may be used for scrambling any of the first sync signal, DMRS of first PBCH and the first PBCH payload. For example, for a set of K scrambling codes (e.g. K may be associated with the periodicity of SSB-a and/or the scaling factor of the periodicity of SSB-b), the WTRU may determine the SFN of SSB-a based on the index of the scrambling code and the association between the K SFNs and K indexes of the scrambling codes.

In another example, the WTRU may determine the cell ID (e.g. PCI) of a cell transmitting the SSB-a based on a scrambling code that may be used for scrambling any of the first sync signal, DMRS of first PBCH and the first PBCH payload of the SSB-a. For example, for a set of L scrambling codes (e.g. L may be associated with the list of cell IDs/PCIs), the WTRU may determine the cell ID based on the index of the scrambling code applied in the received SSB-a and the association between the L cell IDs and L indexes of the scrambling codes.

The WTRU may perform measurements on the received SSB-a signals/beams, possibly received in the determined time/frequency locations. Such measurements, possibly on the one or more of SSB-a signals/beams in a burst, may be associated with any of L3, L2 and/or L1 measurements. Such measurements may be used for selecting a cell, possibly for transmitting UL-WUS indication. For example, the WTRU may select a cell for transmitting UL-WUS based on the measurements of an associated SSB-a and the UL-WUS triggering conditions, e.g. the SSB-a of a cell with the highest RSRP (e.g. SSB-a of a cell with the highest actual RSRP+bias offset).

According to some embodiments, a WTRU may transmit UL-WUS associated with a selected cell. In an example, the WTRU may transmit an UL-WUS indication/signal, possibly when meeting triggering conditions/criteria, based on the measurements made on SSB-a and info received in the first PBCH of SSB-a signals. Such UL-WUS may be transmitted for requesting on-demand SSB-b transmissions from a selected cell.

In an example, the WTRU may transmit the UL-WUS indication to a cell using UL-WUS resource config, possibly indicated in the first PBCH of SSB-a, where the resource may possibly be associated with the SSB-a signals received from one or more cells and selected based on measurements (e.g. best SSB-a). The WTRU may transmit the UL-WUS indication directly to a selected cell (e.g. anchor cell or NES cell) possibly using the resources that may be associated with the selected cell (e.g. cell-specific UL-WUS config, cell-specific preambles/sequences/WUS occasions) when any of the triggering conditions are met.

In another example, the WTRU may send the UL-WUS indication to an anchor cell for requesting OD-SSB-b transmission from the anchor cell or another NES cell that may be controlled or associated with the anchor cell. In this case, the WTRU may indicate info on the selected cell (e.g. indicate the cell ID or a sequence associated with the cell ID) in the UL-WUS transmitted to the anchor WTRU. Alternatively, the WTRU may use any of the resources associated with the selected cell (e.g. cell-specific UL-WUS config, cell-specific preambles/sequences/WUS occasions) when transmitting the UL-WUS to the anchor WTRU. In this case, the WTRU may perform certain cell-specific adjustment to the UL-WUS resources (e.g. apply time/frequency offsets to WUS occasions, apply a scrambling code to UL-WUS resources) based on info received in the first PBCH in SSB-a of the anchor cell and the first PBCH of SSB-a of the selected NES cell, for example, possibly for avoiding any collisions or ambiguity at the anchor cell. Such UL-WUS may be transmitted using the spatial filter associated with the selected cell for transmitting the UL-WUS indication, for example.

In an example, upon performing RSRP measurements of the SSB-a received from one or more cell and ranking the cells based on the measurements, the WTRU may transmit an UL-WUS indication to a selected NES cell. For example, the WTRU may transmit the UL-WUS indication to the selected cell if any of the following triggering conditions are met: RSRP of SSB-a of NES cell (e.g. actual RSRP+bias offset of NES cell) is greater than RSRP of SSB-a of anchor cell (e.g. actual RSRP+bias offset of NES cell), and/or a time gap to nearest always-on SSB-b signal of anchor cell is greater than a time gap threshold.

Alternatively, or additionally, the WTRU may transmit an UL-WUS indication to the anchor cell, if any of the following triggering conditions are met: RSRP of SSB-a of anchor cell (e.g. actual RSRP+bias offset of anchor cell) is greater than RSRP of SSB-a of best NES cell (e.g. actual RSRP+bias offset of the best NES cell), and/or a time gap to nearest always-on SSB-b signal of anchor cell is greater than a time gap threshold.

In some embodiments, the UL-WUS indication may be used for indicating other requests, preference or assistance information, which may be the same as those listed or discussed above. The additional info that may be indicated via the UL-WUS may include cell-specific info (e.g. cell ID). For example, the WTRU may request to increase the periodicity of OD-SSB-b or request to activate a particular SSB-b beam index in one or more cells with PCIs {cell #1, cell #3}. Such preference or assistance info may be indicated by the WTRU using associated UL-WUS resources (e.g. preambles, sequences, RACH/WUS occasions) which may be selected from one or more of the pre-configured/indicated UL-WUS configs.

In an example, the WTRU may include a value associated with the cell (e.g. PCI, cell id/index) with the UL-WUS indication when transmitting the indication directly to the cell or to another associated cell (e.g. anchor cell) when requesting for OD-SSB-b transmission from the cell. Such a value may be explicitly included or may be scrambled on to any of the resources of the UL-WUS indication using an associated scrambling sequence/code. For example, the WTRU may use a scrambling code associated cell #2 for scrambling an UL-WUS resource when sending the UL-WUS to cell #2.

In an example, the WTRU may transmit the UL-WUS during a WUS occasion (WO) in any of time and frequency domains, during which the cell may monitor for any UL-WUS transmission from the WTRU, for example. Such WOs may be associated with the UL-WUS config (provided in first PBCH) and/or the properties of SSB-a (e.g. periodicity, time/frequency location, beams) of the associated cell. In the case when a WUS occasion pattern is configured/indicated (e.g. comprising of time/frequency locations, periodicity of WOs, WO duration, start slot/offset), the WTRU may transmit the UL-WUS indication during the next available WUS occasion, possibly associated with the selected SSB-a of the selected cell. If a WUS occasion pattern is not configured/indicated, the WTRU may assume the availability of a WUS occasion N SFNs/subframes/symbols (e.g. N=1) after the reception of the SSB-a in an SSB-a burst (e.g. last symbol of SSB-a in a burst), for example.

In an example, the WTRU may be configured with one or more UL-WUS resources (e.g. preambles, sequences, WUS/RACH occasions) that may be associated with any of different cells, SSB-a signals/beams/configs and OD-SSB-b configs/signals/beams. The WTRU may select an UL-WUS resource for transmission based on whether the indication is intended to be cell-specific, SSB-a signal specific or OD-SSB-b specific. For example, the WTRU may select a cell-specific UL-WUS resource when transmitting UL-WUS to a particular cell or when requesting OD-SSB-b transmission from a particular cell. In this case, the WTRU may scramble the UL-WUS resource with a cell-specific scrambling sequence when transmitting UL-WUS indication, for example. In another example, the WTRU may select an SSB-a signal/beam specific UL-WUS resource/sequence for indicating a particular SSB-a index/signal/beam that is used as a reference when transmitting UL-WUS. In another example, the WTRU may select an OD-SSB-b signal/beam/config specific UL-WUS resource/sequence when requesting a particular OD-SSB-b signal/beam/config.

The conditions (e.g., triggering conditions) used by the WTRU for determining whether/when to transmit the UL-WUS indication may be related to any of RSRP measurements (e.g. with bias offset) of the SSB-a signals received from a cell, time to the nearest always-on SSB-b signal (if transmitted) of a cell, absence of an indication on OD-SSB-b triggering (e.g. in first PBCH of SSB-a of a cell) and absence of a WUS response indication (for a monitoring duration) from the cell.

In some cases, the WTRU may transmit UL-WUS within k time units (e.g. SFNs, subframes, symbols) upon detecting one or more of the triggering conditions. For example, in the case when always-on SSB-b may be transmitted by a cell with long periodicity, the WTRU may transmit UL-WUS to request for OD-SSB-b transmission if the determined time gap between the last SSB-a signal of a cell and the next/nearest always on SSB-b signal of the cell is greater than a threshold corresponding to X time units (e.g. SFNs, subframes, symbols). The WTRU may use the nearest available WUS occasion of the cell from detecting the trigger, possibly within k time units, for transmitting an UL-WUS indication. Alternatively, the WTRU may trigger and/or transmit UL-WUS indication for requesting on-demand SSB-a transmissions from a cell, possibly when the existing SSB-a signals are insufficient (e.g. periodicity of always-on SSB-a is above a threshold, RSRP measurements of SSB-a is below a threshold).

In an example, the WTRU may perform power control when transmitting UL-WUS indication, where the power control parameters may be determined based on the measurements of SSB-a (e.g. pathloss measurements of a cell) and possibly based on the info received in the first PBCH (e.g. on Tx power of SSB-b, alpha, p0) of SSB-a of the cell.

In an example, the UL-WUS indication may be transmitted with repetitions (e.g. N number of transmissions), where the number of repetitions may be determined based on the RSRP/pathloss measurements made on SSB-a received from the cell. For example, the WTRU may transmit UL-WUS with no repetitions when the measured RSRP is greater than a threshold. The WTRU may transmit UL-WUS with n1 repetitions when the measured RSRP is within a first range and with n2 repetitions when the measured RSRP is within a second range. In this case, different cells may be associated with different number of repetition values.

In an example, the WTRU may start a prohibit timer upon transmitting an UL-WUS indication to a cell. Upon starting the prohibit timer the WTRU may not be allowed to transmit any subsequent UL-WUS indications to the cell until the expiry of the prohibit timer or upon reception of a WUS response indication. In this case, different cells may be associated with different prohibit timer values.

According to some embodiments, a WTRU may receive a WUS response indication from a cell. In an example, the WTRU may receive the WUS response indication from the cell, for example, possibly upon transmitting an UL-WUS indication. Such WUS response indication may be received via an explicit indication (e.g. in a DCI), possibly in a WUS response monitoring configuration (e.g. common search space or CORESET) or via an implicit indication with the reception of OD-SSB-b signals, possibly with a certain predefined/preconfigured start duration after UL-WUS transmission. Such indication may be received from the cell to which the UL-WUS indication may be transmitted or from another cell (e.g. anchor cell) in which the monitoring resources associated with the WUS response indication are located (e.g. common SS/CORESET).

In an example, upon transmitting UL-WUS indication requesting OD-SSB-b transmission from a target NES cell, the WTRU may receive the WUS response indication from the anchor cell or from the target NES cell. Such WUS response from the target NES cell may be received in the same beam indicated by the WTRU in the UL-WUS indication, possibly using a UL-WUS resource associated with the beam index and/or the target cell ID, possibly when transmitting the UL-WUS to the anchor cell.

For receiving an explicit WUS response indication, the WTRU may be configured/indicated (e.g. in first PBCH) with time/frequency monitoring resources, which the WTRU may monitor for a certain time window (e.g. configured with a start time and duration in terms of SFNs, subframes, symbols, ms), possibly with a certain periodicity, which possibly may be cell-specific. The WTRU may start the time window for receiving the WUS response, possibly within m time units (e.g. where the m value may be associated with the cell) upon transmitting the last UL-WUS indication. For example, the WTRU may start a timer associated with the WUS response window m symbols/slots (e.g. m=1) after transmitting the UL-WUS indication. The WTRU may monitor for a WUS response indication while the timer is running, for example. The WTRU may stop and reset the timer, upon receiving a WUS response, for example.

The WUS response indication may be received in any of the L1 signaling (e.g. DCI in PDCCH), L2 signaling or L3/RRC signaling. In some examples, the received WUS response indication may include one or more of the same set of info/parameters described in the previous section of this disclosure. In an example, the WUS response may be received via the same/similar beam (e.g. similar beam properties at WTRU) used by the WTRU for transmitting the UL-WUS indication to a cell. In this regard, the WTRU may monitor for the WUS response using one or more Rx spatial filters (e.g. ports, weights) and beams that may be associated with the spatial filters used for UL-WUS transmission (e.g. same beam and beams that are spatially nearby) to the cell.

In an example, if a WUS response is not received by the WTRU before the end of the monitoring window or before the expiry of a WUS response timer, the WTRU may monitor for an implicit WUS response in the form of initiation of new SSBs, including any of new SSB-a, new always-on SSB-b or new OD-SSB-b transmissions, possibly from the cell to which the UL-WUS indication is transmitted or from another cell (e.g. anchor cell). The monitoring for new SSBs may be done by the WTRU, for certain time duration, before and/or after the end of the monitoring window or the expiry of the WUS response timer, which may be cell-specific. The WTRU may select a new cell or a new SSB based on measurements (e.g. L1 RSRP) and/or using criteria associated with the measurements (e.g. RSRP measurements of the new SSB is above a threshold value and/or highest among the detected new SSBs).

In another example, if an explicit WUS response is not received by the WTRU before the end of the monitoring window or before the expiry of the WUS response timer, the WTRU may retransmit the UL-WUS indication, to the same cell or possibly to another NES cell (e.g. cell with the next highest measured RSRP for the SSB-a) or the anchor cell.

According to some embodiments, a WTRU may determine the time and/or frequency locations of OD-SSB-b of (e.g., associated with) a cell. In an example, the WTRU may determine the candidate time and/or frequency (T/F) locations of the OD-SSB-b signals expected to be received from a cell, for example, based on the information in the first PBCH of SSB-a and/or the WUS response indication. For determining the candidate T/F locations (e.g. the SFNs and the carriers where OD-SSB-b signals may be transmitted) the WTRU may initially determine the periodicity of SSB-a. The WTRU may determine the periodicity of the SSB-a based on monitoring of the SSB-a signals received from the cell in at least 2 occasions. The WTRU may then determine the periodicity of the OD-SSB-b (e.g. containing the MIB/SI) based on periodicity of the SSB-a and the scaling factor (e.g. 2×) indicated in the first PBCH and/or WUS response indication.

In an example, the WTRU may determine which period (e.g. same or subsequent period) relative to the SSB-a transmission includes a transmission of the OD-SSB-b from the cell based on the reception of an SSB-a in a first period. Similarly, the WTRU may determine which period (e.g. same or subsequent period) relative to the UL-WUS transmission includes a transmission of the OD-SSB-b based on the transmission of UL-WUS in a first period. In this case, the period may correspond to any of the SFN, time window, and cycle, for example. The first PBCH of the SSB-a or the WUS response may include a value indicating in which period (e.g. SFN) relative to the period of the SSB-a transmission or the UL-WUS transmission includes a transmission of the OD-SSB-b. For example, a value of 3 may indicate the OD-SSB-b transmission occurs 3 SSB-a time periods (e.g. 3 SFNs) after the period in which the SSB-a is received or in which UL-WUS is transmitted. The WTRU may determine the period in which OD-SSB-b is expected to be received based on a scrambling code/sequence. For example, the first PBCH of the SSB-a or the WUS response indication may be scrambled with a scrambling code/sequence that may indicate a value associated with when the OD-SSB-b is transmitted or received relative to the SSB-a or UL-WUS transmission.

According to some embodiments, a WTRU may receive OD-SSB-b signals from a cell(s). In some examples described herein, the WTRU may receive one or more signals of OD-SSB-b (e.g. signals containing second/third sync signals, second PBCH, MIB/SI) from a cell (e.g. anchor cell or NES cell). Such OD-SSB-b signals may be associated with at least one active OD-SSB-b configuration. Such OD-SSB-b signals, possibly in combination with other always-on SSB-b signals, may be received by the WTRU when supporting any functions associated with IDLE mode (e.g. cell (re)selection, synchronization, SI update, paging) and/or CONNECTED mode (e.g. L1/L3 measurements, RLM, BM).

In an example, upon determining the time and/or frequency locations of OD-SSB-b signals, possibly based on the information in first PBCH if SSB-a signals and/or WUS response indication received from one or more cells, the WTRU may start monitoring at least the nearest determined candidate time/frequency locations from the last received SSB-a signal, UL-WUS transmission or the last WUS response indication (e.g. next candidate SFN from the SFN of last WUS response) for receiving the OD-SSB-b signals from the cell. The received OD-SSB-s signals may be used for any of measurements, cell (re)selection, paging, initial access, etc. The WTRU may receive the OD-SSB-b signals containing MIB and/or the common SS config for receiving PDCCH associated with a target SI (e.g. cell selection info, RACH config). Such PDCCH (e.g. DCI encoded with a SI-RNTI) may indicate the PDSCH in which the target SI may be received.

In an example, the WTRU may receive the OD-SSB-b signals and perform any of measurements, cell selection, etc., while continuing to monitor the WUS response monitoring configuration associated with the target cell or the anchor cell. The WTRU may receive a stopping indication in the monitoring configuration indicating the stopping of OD-SSB-b transmission. Such indication may be received in any of the WUS response indication (e.g. another response indication for stopping) or a DCI (e.g. cell-common or group common DCI). The WTRU may assume the OD-SSB-b transmission is stopped after a preconfigured m time units (e.g. time units may correspond to m SFNs, subframes, symbols, ms) or after certain indicated time units (e.g. in the stopping indication) upon receiving the stopping indication. The WTRU may stop monitoring for OD-SSB-b transmission, possibly after expiry of an associated timer, for example, upon receiving the stopping indication.

In an example, the WTRU may determine the periodicity of the SS for receiving PDCCH for a target SI (e.g. SIBx, possibly for cell selection, initial access) based on the periodicity of the SSB-a and the associated scaling factor indicated in the first PBCH or in the second PBCH of the OD-SSB-b. The WTRU may receive the PDCCH associated with the target SI in the SS according to the determined periodicity of the SS. Upon receiving the target SI (e.g. in PDSCH) the WTRU may transmit an indication to the cell using the resources indicated in the target SI. Such indication transmitted by the WTRU may include a PRACH preamble which may be transmitted in the resources (e.g. WUS/RACH occasions in time and/or frequency domain) which may be associated with one or more properties of SSB-a and/or OD-SSB-b signals (e.g. periodicity, time/frequency location), for example.

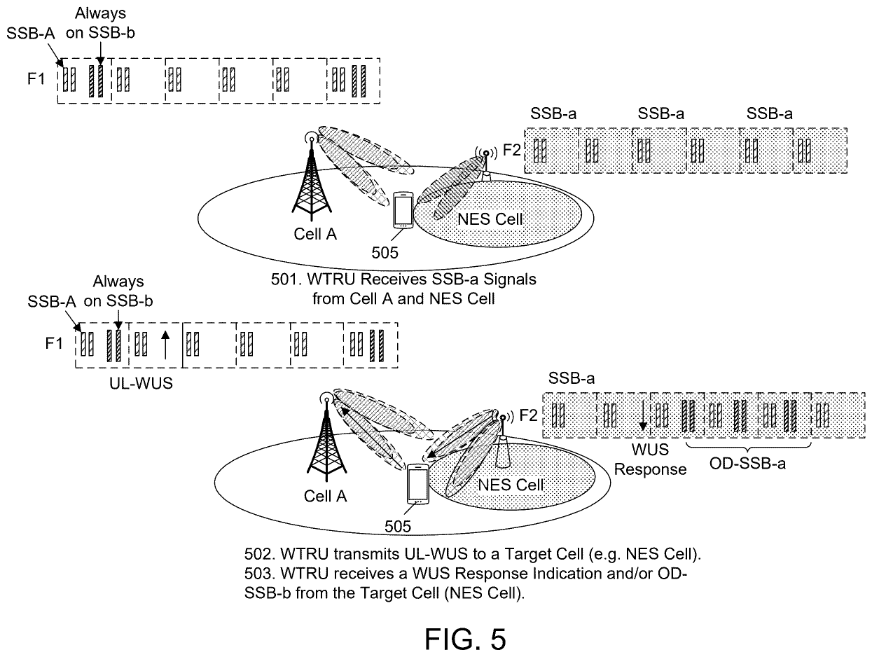

FIG. 5 illustrates an example procedure for UL-WUS transmission (e.g. to an anchor cell A), reception of an WUS response indication (e.g. from a target NES cell) and on demand SSB-b transmission (e.g. from a target NES cell). More specifically, as illustrated in FIG. 5, the WTRU 505 may, as shown at 501, receive SSB-a signals from cell A and/or NES cell. As shown at 502, WTRU 505 may transmit UL-WUS to the NES cell (e.g., target cell) and, at 503, WTRU 505 may receive a WUS response indication and/or OD-SSB-b from the NES cell (e.g., target cell).

As discussed in detail above, according to certain embodiments, a WTRU may receive SSB-a signals, which may include, e.g., sync signals and/or light PBCH. The WTRU may transmit UL-WUS indication using resources provided in the light PBCH of the SSB-a to request for on demand SSB-b signals (e.g., when meeting the triggering criteria). The WTRU may determine the candidate time and/or frequency locations for receiving the on-demand SSB-b signals based on the information in the light PBCH and/or a WUS response indication (e.g., information included in a WUS response indication that is received in response to the UL-WUS indication).

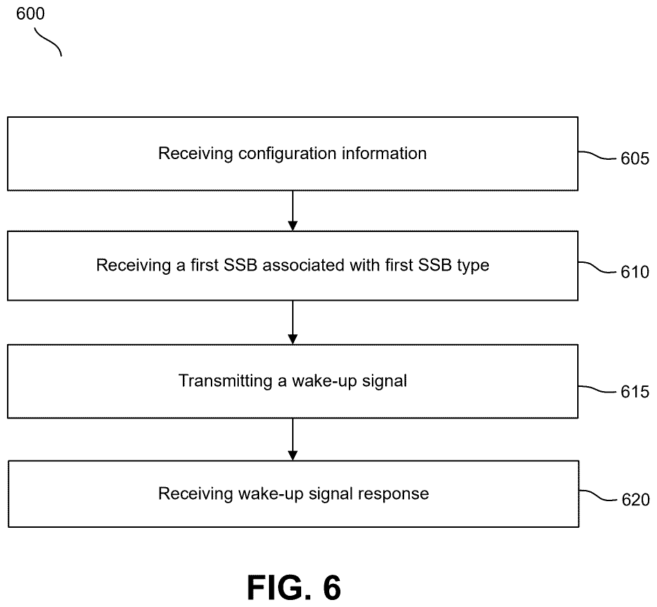

FIG. 6 illustrates an example flow diagram of a method 600 for or relating to reducing RS overhead, e.g., in near field, according to some embodiments. The example method 600 of FIG. 6 and accompanying disclosures herein may include, may be based on, or may be a synthesization of various embodiments or elements discussed in detail above.

For convenience and simplicity of exposition, the example of FIG. 6 may be described with reference to the architecture or system described above with respect to FIGS. 1A-1D, for instance. However, the example method 600 depicted in FIG. 6 may be carried out using different architectures as well. According to some embodiments, the method 600 of FIG. 6 may be performed or implemented by a UE or WTRU, such as the WTRU 102 described in the foregoing or the WTRU illustrated in the examples of FIGS. 4-5.

It is noted that the method 600 of FIG. 6 may include further steps, procedures or details as discussed in detail elsewhere in this disclosure. As such, the method 600 of FIG. 6 may be modified to include any of the steps, procedures, elements and/or details illustrated and/or discussed in the foregoing or the following. For example, additional details regarding the information, parameters, messages, signaling, configurations, etc. described in FIG. 6 have been discussed in detail above.

Moreover, it is noted that the method and/or blocks of FIG. 6 may be modified to include, or to be replaced by, any one or more of the procedures, elements or blocks discussed elsewhere herein. As such, one of ordinary skill in the art would understand that FIG. 6 is provided as one example and modifications thereto are possible while remaining within the scope of certain example embodiments.

As illustrated in the example of FIG. 6, the method 600 may include, at 605, receiving synchronization signal block (SSB) configuration information (e.g., configuration information associated with or relating to one or more SSBs or one or more types of SSBs). In some embodiments, the synchronization signal block (SSB) configuration information may indicate any one or more of: (1) one or more parameters associated with a first synchronization signal block (SSB) type (e.g., a first type of SSB or SSB-a), (2) one or more parameters associated with a second synchronization signal block (SSB) type (e.g., a second type of SSB or SSB-b), (3) one or more wake-up signal (WUS) configuration(s) (e.g., configuration information associated with one or more wake-up signals), and/or (4) an association between the wake-up signal (WUS) configurations and the first synchronization signal block (SSB) type. Additional details regarding the configuration information received at 605, and examples of the information that may be included therein, are discussed above.

In the example of FIG. 6, the method 600 may include, at 610, receiving a first synchronization signal block (SSB) associated with the first synchronization signal block (SSB) type (e.g., SSB-a). According to certain embodiments, the received first synchronization signal block (SSB) may include or may indicate one or more synchronization signals and/or a first type of physical broadcast channel (PBCH) (e.g., light PBCH). The first type of PBCH may include first information indicating any one or more of: (1) a parameter indicating an association between a periodicity of the first synchronization signal block (SSB) type and one or more of the wake-up signal (WUS) configurations and/or (2) wake-up signal monitoring configuration information (e.g., configuration information associated with the monitoring of wake-up signal(s)). Additional details regarding the first SSB received at 610, and examples of the information that may be included therein (e.g., the sync signal(s) and light PBCH), are discussed above.

As illustrated in the example of FIG. 6, the method 600 may include, at 615, transmitting a wake-up signal (WUS). In certain embodiments, the wake-up signal (WUS) may be transmitted using (e.g., based on) one of the wake-up signal (WUS) configurations, which may be determined at least based on the first information included in the first type of physical broadcast channel (PBCH). Additional details regarding the wake-up signal (WUS) transmitted at 615, and examples of the information that may be included therein, are discussed above.

In the example of FIG. 6, the method 600 may include, at 620, receiving a wake-up signal (WUS) response indication based on the wake-up signal monitoring configuration information. Additional details regarding the wake-up signal (WUS) response indication received at 620, and examples of the information that may be included therein, are discussed above.

According to some embodiments, the method 600 (although not explicitly shown in the example of FIG. 6) may include determining, for example based on the first information included in the first type of physical broadcast channel (PBCH) and/or the wake-up signal (WUS) response indication, any of time and/or frequency locations of one or more (e.g., at least one) on-demand synchronization signal block(s) (SSB). The one or more (e.g., at least one) on-demand synchronization signal block(s) (SSB) may be associated with the second synchronization signal block (SSB) type (e.g., the on-demand synchronization signal block (SSB) may be a SSB-b). Additional details regarding the first PBCH, the wake-up signal (WUS) response indication, and examples of the information that may be included therein, and how the WTRU may determine the T/F locations, are discussed above.

In some embodiments, the method 600 (although not explicitly shown in the example of FIG. 6) may include receiving the one or more (e.g., at least one) on-demand synchronization signal block (SSB) in any of the time and/or frequency locations determined by the WTRU. According to an embodiment, the method 600 (although not explicitly shown in the example of FIG. 6) may also include transmitting information or an indication, to a network node, based on information in a selected one of the one or more (e.g., at least one) on-demand synchronization signal block(s) (SSB). For example, in certain embodiments, the WTRU may perform measurements on the received one or more (e.g., at least one) on-demand synchronization signal block(s) (SSB) and may select one of the (e.g., at least one) on-demand synchronization signal block (SSB) (e.g., may select a SSB-b signal or beam that is best or strongest, e.g., having highest RSRP or RSRP above a certain threshold).

In an embodiment, the association between the wake-up signal (WUS) configurations and the first synchronization signal block (SSB) type (e.g., which may be received as part of configuration information at 605) may include an association between the wake-up signal (WUS) configurations and properties associated with signals of the first synchronization signal block (SSB) type. Additional details and examples regarding the associations and the wake-up signal (WUS) configurations, and examples of the information that may be included therein, are discussed above.

In an embodiment, the transmitting of the wake-up signal (WUS) at 615 may include transmitting the wake-up signal (WUS) on condition that a criteria, such as a preconfigured or triggering criteria, is met. For example, the criteria (e.g., triggering criteria) may include any one or more of: a reference signal received power (RSRP) associated with the first synchronization signal block (SSB) being greater than a threshold, and/or a time gap to a nearest synchronization signal block (SSB) of a second synchronization signal block (SSB) type signal being greater than a threshold. Additional details and examples regarding the criteria and/or triggering criteria, and examples thereof, are discussed above.

In an embodiment, the second synchronization signal block (SSB) type (e.g., SSB-b) may include any one or more of always-on synchronization signal blocks (SSBs) and/or on-demand synchronization signal block (SSBs). For example, the always-on synchronization signal blocks (SSBs) are received with a predetermined periodicity, and the on-demand synchronization signal blocks (SSBs) are received in response to a wake-up signal (WUS). Additional details and examples regarding the always-on synchronization signal blocks (SSBs) and/or on-demand synchronization signal block (SSBs), and examples of the information that may be included therein, are discussed above.

In an embodiment, the wake-up signal (WUS) response indication, which may be received as shown at 620, may include or indicate any one or more of: (1) an association between a scaling factor for a periodicity associated with the at least one on-demand synchronization signal block (SSB) and a periodicity associated with the first synchronization signal block (SSB) associated with the first synchronization signal block (SSB) type, (2) an association between a duration of the at least one on-demand synchronization signal block (SSB) and any of a symbol duration and periodicity of the first synchronization signal block (SSB) associated with the first synchronization signal block (SSB) type, and/or any of a start time and frequency offset of the on-demand SSB. Additional details and examples regarding the wake-up signal (WUS) response indication, and examples of the information and/or associations that may be included therein, are discussed above.

In an embodiment, as discussed in detail above, the first type of physical broadcast channel (PBCH) may be a light physical broadcast channel (PBCH) having a smaller payload than a second type of PBCH (e.g., the second PBCH having a complete or normal payload).

In an embodiment, the method 600 (although not explicitly shown in the example of FIG. 6) may include performing measurements on the at least one on-demand synchronization signal block (SSB) to determine the selected one of the at least one on-demand synchronization signal block (SSB) to use to transmit the indication to the network node.

In an embodiment, the method 600 (although not explicitly shown in the example of FIG. 6) may include monitoring resources indicated in the wake-up signal monitoring configuration information for an indication that transmission of the on-demand synchronization signal blocks (SSBs) is or will be terminated.

In an embodiment, the information or indication transmitted to the network node may be or may include a physical random access channel (PRACH) transmission that may be transmitted using resources associated with the selected one of the at least one on-demand synchronization signal block (SSB). Other examples of this indication are discussed above or elsewhere herein.

In an embodiment, the method 600 (although not explicitly shown in the example of FIG. 6) may include, based on the selected one of the at least one on-demand synchronization signal block (SSB), receiving system information (SI) associated with the network node.

In an embodiment, the parameters associated with the first synchronization signal block (SSB) type and the parameters associated with the second synchronization signal block (SSB) type may include, but are not limited to, any one or more of: identifiers associated with the first synchronization signal block (SSB) type and the second synchronization signal block (SSB) type, synchronization signal block (SSB) resources, synchronization signal block (SSB) ports, resource type, active resources in a burst, periodicity, usage type, slot level periodicity, slot level offset, synchronization signal block (SSB) beam bandwidth, frequency hopping information, guard period, synchronization signal block (SSB) comb pattern information, comb offset hopping pattern with repetition, synchronization signals, beam transmit power, power control parameters, and reference beam information. Other examples and details regarding these parameters are discussed in more detail above or elsewhere herein.

In an embodiment, the wake-up signal (WUS) configuration(s) may include an indication of resources associated with the wake-up signal (WUS), or may include other information as discussed in more detail above or elsewhere herein.

An embodiment may be directed to an apparatus, UE or WTRU, such as WTRU 102 or any other WTRU discussed herein, which may include circuitry (e.g., including a processor, transceiver and/or memory). The WTRU may be predefined or preconfigured with (e.g., may receive configuration information indicating) parameters associated with SSB-a configuration(s) and/or SSB-b configuration(s) (e.g., always-on and/or on-demand SSB-b configs) and/or an association between UL-WUS resources and SSB-a. For example, the association between one or more UL-WUS resource configuration(s) and SSB-a configuration(s) may include UL-WUS resources (e.g. PRACH preambles, RACH occasions in TD/FD, etc.) that may be associated with the properties of SSB-a signals (e.g. periodicity, symbol duration, scrambling sequence on sync signal, etc.).

In an embodiment, the WTRU may receive SSB-a signals (e.g., containing sync signal(s) and/or light PBCH). For example, as discussed above or elsewhere herein, a light PBCH may include or may indicate: parameter(s) used in combination with the periodicity of SSB-a for associating with different UL-WUS configuration(s) (e.g. 2 bits for indicating one of 4 UL-WUS configs per SSB-a periodicity), and/or WUS response monitoring configuration (e.g. time, frequency, code resource set, CORESET, search space, etc.) (e.g. 2 bits for indicating one of 4 different monitoring config multiplexing patterns).

In an embodiment, the WTRU may transmit UL-WUS based on SSB-a measurement(s) and/or information in the light PBCH of SSB-a. For example, the UL-WUS may be transmitted when a criteria or triggering criteria is met. For example, the triggering criteria for transmitting the UL-WUS may include any one or more of: RSRP (SSB-a) is greater than a threshold, and/or a time gap to nearest always-on SSB-b signal is greater than a threshold. For example, the UL-WUS may be a cell-specific resource (e.g. sequence, PRACH resource). For example, the WTRU may transmit the UL-WUS using a transmit power level adjusted based on the (pathloss) measurements made on the SSB-a signals.

In an embodiment, the WTRU may receive a WUS response indication(s) using (e.g., based on) the WUS response monitoring configuration. For example, a WUS response may include any one or more of: scaling factor for periodicity of OD-SSB-b may be associated with periodicity of SSB-a (e.g. 2 bits), duration of OD-SSB-b may be associated with symbol duration and/or periodicity of SSB-a (e.g. 2 bits), and/or start time/frequency offset of OD-SSB-b (e.g. 2 bits).

In an embodiment, the WTRU may determines the time and/or frequency (T/F) locations of OD-SSB-b signals based on the information in the light PBCH and/or in the WUS response indication. For instance, for a WUS response indication received in SFN #x, the WTRU may determine the candidate time locations for OD-SSB-b with the indicated start offset (e.g. 1 SFN) and duration (e.g. 4 SFNs) as {SFN #x+1+i, where i=1, 2, 3, 4}.

In an embodiment, the WTRU may receive OD-SSB-b signals in the determined T/F locations. For example, the WTRU may perform measurements on the OD-SSB-b signals (e.g. for the indicated duration based on a timer) and/or may select a best SSB-b signal and/or beam (e.g., strongest beam or beam with highest RSRP, or RSRP above a threshold, etc.). Alternatively or additionally, the WTRU may monitor the resources (indicated or received) in the WUS response monitoring configuration to receive any indication or information regarding the stopping or terminating of OD-SSB-b transmission(s).

In an embodiment, the WTRU may (optionally) determine or select an OD-SSB-b to use (e.g. based on measurements). For example, the WTRU may receive the SI associated with the cell based on the determined OD-SSB-b. The WTRU may transmit an indication (e.g. PRACH) to the cell based on the determined/selected OD-SSB-b (e.g. using PRACH resources associated with the OD-SSB-b).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety:
[1] 3GPP TS 38.214, v18.4.0, Sections [5.1.5, 6.2.1], Sep. 2024;
[2] 3GPP TS 38.213, v18.4.0, Section 7, Sep. 2024.

1. A wireless transmit/receive unit (WTRU), comprising:
circuitry, including any of a processor and transceiver, configured to:
receive synchronization signal block (SSB) configuration information indicating (1) one or more parameters associated with a first synchronization signal block (SSB) type, (2) one or more parameters associated with a second synchronization signal block (SSB) type, (3) one or more wake-up signal (WUS) configurations, and (4) an association between the wake-up signal (WUS) configurations and the first synchronization signal block (SSB) type;
receive a first synchronization signal block (SSB) associated with the first synchronization signal block (SSB) type, wherein the first synchronization signal block (SSB) comprises one or more synchronization signals and a first type of physical broadcast channel (PBCH), the first type of PBCH comprising first information indicating (1) a parameter indicating an association between a periodicity of the first synchronization signal block (SSB) type and one or more of the wake-up signal (WUS) configurations and (2) wake-up signal monitoring configuration information;
transmit a wake-up signal (WUS) using one of the wake-up signal (WUS) configurations determined at least based on the first information included in the first type of physical broadcast channel (PBCH); and
receive a wake-up signal (WUS) response indication based on the wake-up signal monitoring configuration information.

2. The WTRU of claim 1, configured to:
determine, based on the first information included in the first type of physical broadcast channel (PBCH) and the wake-up signal (WUS) response indication, any of time and frequency locations of at least one on-demand synchronization signal block (SSB), wherein the at least one on-demand synchronization signal block (SSB) is associated with the second synchronization signal block (SSB) type.

3. The WTRU of claim 2, configured to:
receive the at least one on-demand synchronization signal block (SSB) in any of the time and frequency locations; and
transmit an indication, to a network node, based on resource information in a selected one of the at least one on-demand synchronization signal block (SSB).

4. The WTRU of claim 1, wherein the association between the wake-up signal (WUS) configurations and the first synchronization signal block (SSB) type comprises an association between the wake-up signal (WUS) configurations and properties associated with signals of the first synchronization signal block (SSB) type.

5. The WTRU of claim 1, wherein the wake-up signal is transmitted on condition that a triggering criteria is met, the triggering criteria comprising any of: a reference signal received power (RSRP) associated with the first synchronization signal block (SSB) being greater than a threshold, and a time gap to a nearest synchronization signal block (SSB) of a second synchronization signal block (SSB) type signal being greater than a threshold.

6. The WTRU of claim 1, wherein the second synchronization signal block (SSB) type comprises any of always-on synchronization signal blocks (SSBs) and on-demand synchronization signal block (SSBs), wherein the always-on synchronization signal blocks (SSBs) are received with a predetermined periodicity, and wherein the on-demand synchronization signal blocks (SSBs) are received in response to a wake-up signal (WUS).

7. The WTRU of claim 2, wherein the wake-up signal (WUS) response indication indicates any of: (1) an association between a scaling factor for a periodicity associated with the at least one on-demand synchronization signal block (SSB) and a periodicity associated with the first synchronization signal block (SSB) associated with the first synchronization signal block (SSB) type, (2) an association between a duration of the at least one on-demand synchronization signal block (SSB) and any of a symbol duration and periodicity of the first synchronization signal block (SSB) associated with the first synchronization signal block (SSB) type, and (3) any of a start time and frequency offset of the on-demand SSB.

8. The WTRU of claim 1, wherein the first type of physical broadcast channel (PBCH) comprises a light physical broadcast channel (PBCH) having a smaller payload than a second type of physical broadcast channel (PBCH).

9. The WTRU of claim 2, configured to perform measurements on the at least one on-demand synchronization signal block (SSB) to determine the selected one of the at least one on-demand synchronization signal block (SSB) to use to transmit the indication to the network node.

10. The WTRU of claim 1, configured to monitor resources indicated in the wake-up signal monitoring configuration information for an indication that transmission of the on-demand synchronization signal blocks (SSBs) is or will be terminated.

11. The WTRU of claim 3, wherein the indication transmitted to the network node comprises a physical random access channel (PRACH) transmission that is transmitted using resources associated with the selected one of the at least one on-demand synchronization signal block (SSB).

12. The WTRU of claim 3, configured to, based on the selected one of the at least one on-demand synchronization signal block (SSB), receive system information (SI) associated with the network node.

13. The WTRU of claim 1, wherein the parameters associated with the first synchronization signal block (SSB) type and the parameters associated with the second synchronization signal block (SSB) type comprise any of: identifiers associated with the first synchronization signal block (SSB) type and the second synchronization signal block (SSB) type, synchronization signal block (SSB) resources, synchronization signal block (SSB) ports, resource type, active resources in a burst, periodicity, usage type, slot level periodicity, slot level offset, synchronization signal block (SSB) beam bandwidth, frequency hopping information, guard period, synchronization signal block (SSB) comb pattern information, comb offset hopping pattern with repetition, synchronization signals, beam transmit power, power control parameters, and reference beam information.

14. The WTRU of claim 1, wherein the wake-up signal (WUS) configurations comprises an indication of resources associated with the wake-up signal (WUS).

15. A method, implemented by a wireless transmit/receive unit (WTRU), the method comprising:
receiving synchronization signal block (SSB) configuration information indicating (1) one or more parameters associated with a first synchronization signal block (SSB) type, (2) one or more parameters associated with a second synchronization signal block (SSB) type, (3) one or more wake-up signal (WUS) configurations, and (4) an association between the wake-up signal (WUS) configurations and the first synchronization signal block (SSB) type;
receiving a first synchronization signal block (SSB) associated with the first synchronization signal block (SSB) type, wherein the first synchronization signal block (SSB) comprises one or more synchronization signals and a first type of physical broadcast channel (PBCH), the first type of PBCH comprising first information indicating (1) a parameter indicating an association between a periodicity of the first synchronization signal block (SSB) type and one or more of the wake-up signal (WUS) configurations and (2) wake-up signal monitoring configuration information;
transmitting a wake-up signal (WUS) using one of the wake-up signal (WUS) configurations determined at least based on the first information included in the first type of physical broadcast channel (PBCH); and
receiving a wake-up signal (WUS) response indication based on the wake-up signal monitoring configuration information.

16. The method of claim 15, comprising:
determining, based on the first information included in the first type of physical broadcast channel (PBCH) and the wake-up signal (WUS) response indication, any of time and frequency locations of at least one on-demand synchronization signal block (SSB), wherein the at least one on-demand synchronization signal block (SSB) is associated with the second synchronization signal block (SSB) type.

17. The method of claim 16, comprising:
receiving the at least one on-demand synchronization signal block (SSB) in any of the time and frequency locations; and
transmitting an indication, to a network node, based on resource information in a selected one of the at least one on-demand synchronization signal block (SSB).

18. The method of claim 15, wherein the association between the wake-up signal (WUS) configurations and the first synchronization signal block (SSB) type comprises an association between the wake-up signal (WUS) configurations, properties associated with signals of the first synchronization signal block (SSB) type.

19. The method of claim 15, wherein the transmitting of the wake-up signal comprises transmitting the wake-up signal on condition that a triggering criteria is met, the triggering criteria comprising any of: a reference signal received power (RSRP) associated with the first synchronization signal block (SSB) being greater than a threshold, and a time gap to a nearest synchronization signal block (SSB) of a second synchronization signal block (SSB) type signal being greater than a threshold.

20. The method of claim 15, wherein the wake-up signal (WUS) response indication indicates any of: (1) an association between a scaling factor for a periodicity associated with the at least one on-demand synchronization signal block (SSB) and a periodicity associated with the first synchronization signal block (SSB) associated with the first synchronization signal block (SSB) type, (2) an association between a duration of the at least one on-demand synchronization signal block (SSB) and any of a symbol duration and periodicity of the first synchronization signal block (SSB) associated with the first synchronization signal block (SSB) type, and (3) any of a start time and frequency offset of the on-demand synchronization signal block (SSB).
